(19) United States
(12) Patent Application Publication
(10) Pub. No.: US 2006/0212280 A1
(43) Pub. Date: Sep. 21, 2006

(54) Ross model of the universe

(76) Inventor: John R. Ross, Del Mar, CA (US)

Correspondence Address: John R. Ross, 13020 Long Boat Way, P.O. 2138, Del Mar, CA, 92014, US

(21) Appl. No.: 11/415,605

(22) Filed: May 1, 2006

Related U.S. Application Data
(63) Continuation-in-part of application No. 11/108,938, filed on Apr. 18, 2005.
Application No. 11/108,938 is a continuation-in-part of application No. 10/655,817, filed on Sep. 5, 2003.
Application No. 11/108,938 is a continuation-in-part of application No. 10/436,286, filed on May 12, 2003, now abandoned.
Application No. 11/108,938 is a continuation-in-part of application No. 10/251,577, filed on Sep. 21, 2002, now abandoned.
Application No. 11/108,938 is a continuation-in-part of application No. 09/908,297, filed on Jul. 17, 2001, now abandoned.
Application No. 10/655,817 is a continuation-in-part of application No. 10/161,823, filed on Jun. 3, 2002, now abandoned.

(51) Int. Cl. G06F 17/10

(52) U.S. Cl. 703/2

(57) ABSTRACT

A process for describing everything in the universe. My preferred process is in the form of a model. It is the simplest yet model of the universe. I call my first preferred model the “The Ross Model of the Universe” or the “Ross Model”. Processes described and claimed herein can be used to describe and explain all elements of the universe. The model includes a single fundamental particle having no mass and no volume but having a charge of plus e or minus e (+or −1.602×10⁻¹⁹ Coulomb). I have named these particles, “tronnies”. The model proposes a single fundamental force in the universe (from which all other forces are derived). This force is the well known Coulomb force that is carried by the tronnies by virtue of their charges. The model includes a universal energy quantum that I have named “entron”. Entrons are comprised of two tronnies (a plus tronnie and a minus tronnie) and have no net charge but do have mass and energy. My preferred model can be used to describe photons, electrons, electricity, protons, neutrons, atomic nuclei, atoms, molecules, heat, temperature, magnetism, gravity and everything else in the universe.

This Application is a Continuation-in-Part Application of Ser. No. 11/108,938 filed Apr. 18, 2005 which was a Continuation in Part of Ser. No. 10/655,817 filed Sep. 5, 2003, Ser. No. 10/436,286 filed May 12, 2003, Ser. No. 10/251,577 filed Sep. 21, 2002 and Ser. No. 09/908,297, filed Jul. 17, 2001, which was a Continuation-in-Part of Ser. No. 10/161,823 filed Jun. 3, 2002, now abandoned, all of which are incorporated herein by reference. The present invention relates to processes for analyzing nature and in particular for making and supporting models for analyzing photons and everything else the universe.

### BACKGROUND OF THE INVENTION

### Search for the Truth

Since the beginning of human civilization mankind has searched for explanations of the origin of the universe, how it was put together and how it works. Early explanations involved supernatural beings and religions evolved from these efforts. More recent explanations have involved complicated mathematical explanations based on experimental evidence, some involving multiple extra dimensions. Many millions of dollars are being spent in the United States alone and similar efforts are underway in other countries in search of the ultimate building blocks of the universe and a theory or explanation that fully explains all of nature. This sought after theory is referred to as the “theory of everything”.

### Elementary Particles, Forces and Radiation

Popular theories propose a complicated set of elementary particles that are supposed to be building blocks of matter. These include electrons (positive and negative) and six types of quarks (three of which make a proton and three of which make a neutron) and neutrinos. Neutrinos are supposed to be produced in the sun, have the same spin as the electron, travel at, or very close to, the speed of light and most of them that illuminate the earth, according to accepted theories, pass right through it. Popular theories also include a complicated set of forces. These include electromagnetic forces (that combines the Coulomb forces with magnetic forces), the “strong” force holding atomic nuclei together, a “weak” force related to beta particle decay and the force of gravity. Prior art theories include a spectrum of electromagnetic radiation, including cosmic rays, gamma rays, x-rays ultraviolet light, visible light, infrared light, millimeter waves, microwaves and radio waves. These theories include the photon which is supposed to be quantum of electromagnetic energy having some features of a particle.

### The Speed of Light

In 1887 A. A. Michelson and E. W. Morley measured the speed of light in the direction of the earth's travel through the universe, in the opposite direction and in other directions. They determined with great accuracy that the measured speed was constant in eVery direction even though it was known that the earth on which the measurements were made was traveling through the universe at speeds of at least 30,000 meters per second, (about 0.01 percent of the speed of light. This result surprised scientists at that time because they expected that light traveled at a constant speed through an invisible ether (that was believed to fill the universe and provide a medium through which light could travel as a wave) so that if the earth was approaching a light beam through the ether, the measured speed should have been the sum of the earth's speed plus the constant speed of light. And if the earth were traveling away from the light beam, the measured speed of the beam should have been the difference between the light speed and earth's speed.

### Theories of Relativity

Albert Einstein in 1905 developed his Special Relativity Theory based on this “constant” speed of light. This theory greatly complicated physics since a constant light speed meant other things must change in weird ways. Time must slow down and distances become shorter in a fast moving space ship, simultaneous events in a first frame of reference are not simultaneous in a second frame moving relative to the first. A twin astronaut returning to earth after a long fast space journey would discover that his twin brother who stayed behind would be much older than the astronaut. Einstein's special theory did not deal with acceleration and gravity but his General Theory of Relativity did. His general theory, attempting to explain gravity further complicated physics proposing for example that large masses produce a curvature of space.

### String Theories

Various String Theories also attempt to explain how the universe functions. Relatively very few people understand Einstein's General Theory of Relativity or these string theories. I am one of the many who do not.

### Mass, Energy and Physics Units

The prior art includes precise measurements of the masses of atoms and particles and precise measurements of many physics parameters needed to understand the present invention. I list some of these below for convenience of the reader.

### Mass and Energy

Some important particles are listed below with their masses in kilograms and equivalent energy values in millions of electron volts:

| | | Mass | Energy |
|---|---|---|---|
| Particle or Atom | Symbol | (kg) | (MeV) |
| Electron at rest | e− | 9.109 3897 × 10⁻³¹ | 0.510 712 57 |
| Positron at rest | e+ | 9.109 3897 × 10⁻³¹ | 0.510 712 57 |
| Proton | p | 1.672 6231 × 10⁻²⁷ | 938.272 338 |
| Neutron | n | 1.674 9286 × 10⁻²⁷ | 939.565 628 |
| Deuteron | d | 3.343 5860 × 10⁻²⁷ | 1875.613 39 |
| Tritium isotope | ³H | 5.008 2711 × 10⁻²⁷ | 2807.857 70 |
| Hydrogen one atom | ¹H | 1.673 5340 × 10⁻²⁷ | 938.256 992 |
| Helium 4 atom | ⁴He | 6.646 4835 × 10⁻²⁷ | 3726.311922 |

Conversion Units

Some important conversion units are listed below:

| | | |
|---|---|---|
| One electron volt | eV = 1.602 177 33 × 10⁻¹⁹ J | Joules |
| | eV = 1.783 662 70 × 10⁻³⁶ kg | kilograms |
| One atomic mass | amu = 1.660 5402 × 10⁻²⁷ kg | kilograms |
| unit | | |
| One kilogram | kg = 8.987551787 × 10¹⁶ J | Joules |
| Joule (energy) | J = kgm²/s² | kilogram meter |
| | | squared per second |
| | | squared |
| Newton (force) | N = kgm/s² | kilogram meter per |
| | | second squared |
| Universal Constants | | |
| Speed of light | c = 2.99 792 458 × 10⁸ m/s | meters per second |
| in vacuum | | |
| Planks constant | h = 6.626 0755 × 10⁻³⁴ Js | Joule-second |
| | h = 4.135 6692 × 10⁻¹⁵ eVs | electron-volt |
| | | seconds |
| Avogadro constant | N_{A} = 6.022 1367 × 10²³/mol | per mole |
| Coulomb constant | k = 8.99 × 10⁹ Nm²/C² | Newton meter²/ |
| | | Coul² |
| Electron Charge | | |
| Elementary charge | e = 1.602 177 33 × 10⁻¹⁹ C | Coulombs |

Coulomb Force, F, between stationary charged particles:
F=kQ₁Q₂/r²,
where k=9×10⁹ N−m²/C², Q₁ and Q₂ are the charges in Coulombs of the particles and r is the distance between the particles.
E=mc²

The most famous equation in science is E=mc². This says that mass and energy are equivalent and that mass can be converted into energy and vice versa. A prior art example of this is pair production in which a gamma ray photon (which is thought to be pure energy according to prior art theories) with energy equal to 1.02 MeV (1.63×10⁻¹³ Joules) can result in the creation of an electron and a positron (with a combined mass of 1.82×10⁻³⁰ kg) when the gamma ray interacts with matter. One Joule, J, equals one (kg)(m²)/s². The speed of light c is about 2.99×10⁸ m/s and:
E=mc², so:
m=E/c² so:
m=1.634×10⁻¹³ Joule/8.99×10¹⁶ m²/s²=1.82×10⁻³⁰ kg,
which is equal to the combined masses of an electron and a positron, i.e.:
2×9.109×10⁻³¹ kg =1.82×10⁻¹⁰ kg.

The positively charged positron quickly combines with an electron and they annihilate each other and in the process produce photons with energy equal to 1.02 MeV demonstrating mass being converted back into energy. Nuclear reactors and atomic and hydrogen bombs are also prior art examples of mass being converted into energy. The prior art does not provide a good explanation as to how this conversion of energy into mass and vice versa takes place. The prior art does talk about a thing called binding energy that is different in different nuclei. Energy equal to the change in binding energy is released when certain atoms split in fission reactions and certain other atoms are joined in fusion reactions. But there is no good explanation of what binding energy really is.

### Features of Prior Art Models That Don't Make Sense

There are many features of the generally accepted physics and chemistry theories (mostly incorporated into a prior art theory known as the “Standard Model”) that do not make sense. Here are some of these important features, some of which are mentioned above:

The Photon: The prior art does not provide a good description of a photon. Scientist can not decide whether it is a particle or a wave. Some say it is both. Some say it is a wave function, what ever that means.

The Electron: The prior art does not have a good model of the electron. It is suppose to have spin but does not spin. It is point-like, but probably not a point. They say it is probably smaller than 10⁻¹⁸ m but cannot fit inside the nucleus of an atom that is a thousand times larger. They say there are no electrons in nuclei, but electrons (both positive and negative) are often detected coming out of nuclei. The prior art does not provide a good explanation as to why the negative charge of the electron (assuming it is not a point) does not blow the electron apart. Some scientists believe the electron is also a wave function.

Protons: The prior art does not provide a good model of the proton. It is suppose to be comprised of quarks having charges of fractions of the electron charge, but no such fractional charges have ever been detected. And no one has ever detected a quark.

Fundamental Particles and Force Carriers: Fundamental particles are too complicated and too many. According to the Standard Model there are twelve fundamental matter particles (plus their antiparticles). These are: six types of quarks (which are supposed to be the constituents of protons and neutrons) and six types of leptons (one of which is the electron). There are also four types of force carriers: gluons, photons, W bosons and Z bosons.

Gravity: There is no good description of the force of gravity, even though scientists have been looking for such a good description for centuries. There is no good description of Black Holes or of what goes on inside Black Holes.

Time, Mass and Distances Are Relative: Many scientists believe that time slows down, fixed masses get larger and the lengths of things get shorter when you go fast.

Uncertainty: According to prior art theories uncertainty is a basic feature of the universe. This feature says that we can never know the exact position and momentum of a particle. This basic feature is often expressed as:
(Δx)(Δp)≧h/2π.

According to prior art theories these uncertainties are not the result of our inability to measure things accurately but “they are inherent in the wave character of material objects”.

Where Did We Come From—Where Will We Go: The prior art does not have a good explanation for the beginning of the universe. It proposes a Big Bang and an inflation period where the universe expanded much faster than the speed of light from a very small volume to a substantial fraction of the size of the present universe. There is no good explanation as to how our current universe could have been compressed into a very small volume or how things could go faster than the speed of light during the inflation period. There is no good prediction of or agreement as to how our universe will end.

### Need for a Simpler Theory of Everything

Stephen Hawkins in his book, The Theory of Everything, complained that science had become too complicated for philosophers and that they had ceased asking questions such as “Did the universe have a beginning?” and he concluded his text as follows: “However, if we discover a complete theory, it should in time be understandable in broad principal by everyone, not just a few scientists. Then we shall all be able to take part in the discussion of why the universe exists. If we find the answer to that, it would be the ultimate triumph of human reason. For then we would know the mind of God.”

What is needed is a process for modeling photons, electrons, protons, neutrons, atoms, molecules, electricity, magnetism, heat and everything else in the universe.

### SUMMARY OF THE INVENTION

### Ross Model of the Universe

I have proposed here a process for describing everything in the universe. My preferred process is in the form of a model. It is the simplest yet model of the universe. I call my first preferred model the “The Ross Model of the Universe” or the “Ross Model”. Processes described and claimed herein can be used to describe and explain all elements of the universe. The model includes a single fundamental particle having no mass and no volume but having a charge of plus e or minus e (+or −1.602×10⁻¹⁹ Coulomb). I have named these particles, “tronnies”. The model proposes a single fundamental force in the universe (from which all other forces are derived). This force is the well-known Coulomb force that is carried by each tronnie by virtue of its charge. The model includes a universal energy quantum that I have named “entron”. Entrons are comprised of two tronnies (a plus tronnie and a minus tronnie) and have no net charge but do have mass and energy. My preferred model can be used to describe photons, electrons, electricity, protons, neutrons, atomic nuclei, atoms, molecules, heat, temperature, magnetism, gravity and everything else in the universe.

The reader should understand that I am, in this specification, attempting to provide a process and a model for describing everything in the universe from photons to galaxies. I have attempted to be as specific as feasible in providing detailed descriptions of my invention and discoveries. In providing these detailed descriptions, I have undoubtedly made errors. The reader is encouraged to locate those errors and inform me of them if the reader is so inclined. In any event, as I become aware of errors in my model I will correct my model. I realize that many very smart, well educated people will be inclined to dismiss everything about this model since it clearly is inconsistent with prior art descriptions of the universe, such as the generally accepted Standard Model and Einstein's general and special theories of relativity. To those people I say, if you want to continue believing in twelve fundamental particles and several basic forces, that is ok with me. I have discovered a model for describing the universe with one particle and one force and without the complications of Einstein's theories. This model of the universe can be used to explain many features better and more simply that prior art models. Therefore, it should be useful even if some of the explanations are later determined to be in error. I hope to patent my discovery. Important features of a preferred model of the universe are described below:

### Symmetry in the Universe

According to the Ross Model the universe is a very symmetric place. The number of plus tronnies in the universe exactly equals the number of minus tronnies. Everything in the universe is made from one type of particle (the tronnie) and its anti-particle, also a tronnie. At the basic particle level nothing exists in the universe except plus and minus tronnies. If these particles could combine with their anti-particles, the resulting combination of the plus and minus would be zero—nothing. If they could be combined to produce nothing, then they could have been produced from nothing (i.e. empty space). This simple symmetry permits an explanation of how a universe with billions of galaxies could have been created from nothing, i.e. empty space. This model (unlike all prior models) explains that there are an equal number of positrons and electrons in the universe and explains where the missing positrons are (i.e. hidden away in protons). The model (based on building blocks having no volume and no mass) permits the compaction of a universe of billions of galaxies into a basketball-size volume, which is the estimated size of our universe just prior to the “big bang”.

### Tronnies

Tronnies are the single basic particle from which the universe is constructed. Tronnies have no mass, no energy and no volume but each tronnie has a charge equal to plus e or minus e (i.e. a charge of about ±1.602×10⁻¹⁹ C). By virtue of its charge, each tronnie carries the Coulomb force. The Coulomb force expands out from instantaneous positions of the tronnie at the speed of light. Each tronnie is repelled by the force fields of tronnies with like charges and attracted by the force fields of tronnies with opposite charges. Tronnies having no mass can not resist their own repulsive speed-of-light Coulomb force field, so they repel themselves at the speed of light or greater. They can never travel more slowly than the speed of light!

### Creation of the Tronnies

The Ross Model can explain virtually everything in the universe and it can be used to suggest that matter could be created out of nothing as explained above. But the model does require the existence of an extremely large number of tronnies. These tronnies could be tronnies left over from a previous universe after it was condensed into a tiny ball preceding the big bang. The tronnies of that universe could have come from a universe preceding it and so forth and so long for millions of universes. However, at and before the very beginning, prior to any universe, there must have been nothing in existence. The question is: “How were the tronnies first created from nothing?” The Ross Model does not explain how the tronnies were initially created from nothing at the very beginning. I have spent a lot of time unsuccessfully trying to explain how it was done. I believe they were created from nothing but I do not know how. Mathematically it is easy. Plus any number added to the negative of the number is zero. And we know that if we add a negative charge of any value to a positive charge of the same value we get zero. But how did we go from empty space (and zero charge) to many billion trillion plus tronnies and exactly the same number of minus tronnies. I don't know. Others may want to speculate and someone may discover a good scientific answer. Some may want to propose a religious explanation. I am open to all suggestions.

### Entrons

Tronnies tend to pair up with a plus tronnie and a minus tronnie in the form of an entron. An entron is comprised of one plus tronnie and one minus tronnie with each tronnie of the entron traveling in circles faster than the speed of light (typically πc/2, in the entron's reference frame). The entron is the basic mass-energy quantum in the universe. Its mass Menon is the net integrated Coulomb forces acting between its two tronnies and is a function of the entron diameter d′ (the separation of the two tronnies):
mₑₙₜᵣₒₙ=(6.92×10⁻⁴⁵ kg-m)/d′
and the entron's rest energy, Eentron, corresponding to its mass is:
Eₑₙₜᵣₒₙ=(6.22×10⁻²⁸ J-m)/d′=3.88×10⁻⁹ eV-m/d′.

Each photon is comprised of one entron. In addition to photons, entrons may be intergral parts of particles such as protons, atoms, molecules and high-energy electrons. Entrons circling through electrons provide the electron its electrical energy and control its speed. Entrons trapped in matter represent the matter's heat energy and determine its temperature. Tronnies of entrons may trade partners with tronnies of other entrons to produce entrons with different energies.

### Photons

Entrons released from matter continue to circle with the same frequency as when trapped; however entrons may also speed off at the speed of light. An entron cannot however travel in a straight line. To do so while circling at 1.57 c would require its tronnies to go slower than the speed of light during part of each cycle. As a consequence an entron travels in a looping path defining a photon. The width of the entrons path is one-half the photon's wavelength A which is about 53.3 times larger than the diameter of its own circle. This looping configuration is a photon and the photon does travel in a straight line at the speed of light with the entron as a component part traveling twice as far as the photon itself. The looping path of the entron defines the photon's frequency and wavelength. The entron's mass corresponds to one-third of the photon's total energy. The other two thirds of the photon energy is its kinetic energy (which is equal to ½ mv²) where m is the mass of the photon, v is the average velocity of the entron within the photon which is 2 c, where c is the speed of light. The entron's diameter d′ is related to the wavelength λ of the photon by the following equation:
λ=106.64d′

The photon's energy Ek is thus equal to:
Ek=½(mv²)=½((m/d′)(2c)² Ek=2 mc²,
where, as explained above, m is the entron mass, (6.92×10⁻⁴⁵ kg-m)/d′, so
Ek=2((6.92×10⁻⁴⁵ kg-m)/d′)(3×10⁸ m/s)2 Ek=1.25×10⁻²⁷ J-m/d′.

So the total photon energy, Et in:
Et=Er+Ek=0.622×10⁻²⁷ J-m/d′+1.25×10⁻²⁷ J-m/d′=1.87×10⁻²⁷ J-m/d′

Since λ=106.64 d′, we have:
Et=(1.87×10⁻²⁷ J-m/d′)(106.64d′/λ)=1.99×10⁻²⁵ J-m/λ

To check, we know that photon energy Et=hc/λ, where h is Planck's constant, so:
Et=(6.626×10⁻³⁴ Js)(3×10⁸ m/s)/λ which is:
Et=1.99×10⁻²⁵ J-m/λ

### Electrons and Positrons

Three high-energy entrons (comprising three plus tronnies and three minus tronnies) combine in pair production to form an electron and a positron (together comprising three plus tronnies and three minus tronnies). The kinetic energy of the photons that the entrons were a part of do not contribute to the masses to the electron and the positron. Thus, mass is conserved and charge is conserved. Based on this embodiment of the Ross Model, you cannot make an electron without also making a positron. Also, the only way to destroy an electron is to annihilate it with a positron. So, there is exactly the same number of positrons as there electrons in the universe.

### Protons and Neutrons

A proton is comprised of two positrons and one electron, all three of which have captured a very high-energy entron (the entron of a neutrino photon) with a energy mass of 5.5×10⁻²⁸ kg to increase their mass from 9.1×10⁻³¹ kg a little more than 600 times to provide the proton mass of 1.67×10⁻²⁷ kg. Thus, a proton gets its net charge of plus e from the addition of charges of the two positrons and the single electron. It gets almost all of its mass from the high energy entrons captured by the electron and two positrons. A neutron is basically a high-energy hydrogen atom, i.e. a proton circled by a very fast high-energy electron driven by a captured 0.74 MeV gamma ray entron.

### Selif-Propelled Velocities of Sub-Atomic Particles

Sub-atomic particles are all self-propelled by the Coulomb forces of the tronnies of which they are made. All tronnies are self-propelled at velocities of the speed of light, c, or greater. Photons are self-propelled at a velocity of c (the measured photon velocity in a vacuum). The entron inside of each photon is self-propelled with its velocity (relative to a reference frame through which the photon is passing) varying along each photon wavelength from minus 0.57 c to plus 2.57 c and at an average velocity of 2 c. “Naked” electrons and “naked” positrons are self-propelled at a velocity of 2.18×10⁶ m/s giving them a “naked kinetic energy” (½)(mv²)=(½)(9.109×10⁻³¹kg)(2.18×10⁶ m/s)2=2.16×10⁻¹⁸ J or about 13.5 eV. Naked electrons and naked positrons capture low energy entrons to slow down, but the capture of entrons with energies greater than about 13.5 eV drives them in directions opposite their natural direction. The capture of a 300 MeV entron by an electron will drive the electron to speeds of about 0.99999 times the speed of light. Naked protons are also self-propelled by their own internal Coulomb forces at velocities of about 3.6×10⁷ m/s (about 12 percent of the speed of light) giving them a kinetic energy of about 7 MeV. The proton must capture about 7 MeV of entron energy in order to slow down enough to capture an electron to form a hydrogen atom. This entron energy is given up as gamma ray energy when hydrogen nuclei fuse to form helium. Naked alpha particles are also self-propelled at energies of about 6 MeV. They also must capture gamma ray entrons to slow down to become the nucleus of a helium-4 atom.

### Electric Energy, Heat, Magnetism, Pair Production and Gravity

Electric Energy

All electrons in atoms that are in their ground states circling the nuclei of an atom, are electrons with no captured entrons and in the Ross Model they are called “naked electrons” as explained in the above section. They are circling the nucleus at a velocity of about 2.18×10⁶ m/s. (This is a very high speed, almost 5 million miles per hour.) Conduction electrons typically have captured at least one entron and would be traveling at a velocity different from 2.18×10⁶ m/s (usually much slower). Entrons captured by atomic electrons (in addition to normally slowing them down) also put them in excited states. They drop from their excited states to a lower excited state or ground state by releasing the entrons (often as photons) and (if at the ground state) speed back up to 2.18×10⁶ m/s. The entrons trapped by conduction electrons define the electron's energy or voltage. The tronnies of low-energy entrons (less energetic than 13.5 eV) loop through electrons and the Coulomb forces from the looping tronnies provide a backward force on the electrons to slow down the electrons to reduce the electron velocity and kinetic energy. A 13.5 eV entron reduces the electron velocity to about zero. Higher energy entrons give the electron a velocity that can be any velocity up to very close to the speed of light in a direction opposite the direction of its naked velocity.

Heat and Thermal Radiation

Entrons trapped in atoms and molecules also put them in excited states. The entrons can be released as photons (typically thermal radiation) causing the atoms and molecules to drop to a lower energy state or their ground state.

Static Electric Potential, Electric Fields and Magnetic Fields

In conductors at equilibrium, all conduction electrons have captured entrons with the same energy. Any difference in energies is resolved extremely quickly by a flow of electric current from regions of high entron energy to low entron energy. This flow is, for the most part, accomplished by entrons jumping from one electron to another. The tronnies of low energy entrons may be temporally pushed out of the conductor to circle it as a magnetic field. Electric fields are circling entrons usually located in a region between conductors of differing electrical potential. The tronnies of a large number of entrons can join together in long continuous (+, −, +, −, +, −) looping lines to produce force lines of a magnetic field. The space between the tronnies in the looping lines corresponds to the entron energy. In electronic devices such as oscillators, entron energy travels back and forth between electric fields (where two tronnies are circling) and magnetic fields (where one of the entron's tronnies follows the other in a line of tronnies).

Pair Production

According to my preferred model pair production requires the entrons of three high-energy gamma ray photons. The three plus tronnies and three minus tronnies in the three gamma ray photons combine to form an electron (with two minus tronnies and one plus tronnie) and a positron (with two plus tronnies and one minus tronnie). The three gamma ray photons must be in the same place at the same time for pair production to take place. Therefore, pair production should be very rare at low gamma ray fluxes. It should also decrease with increasing gamma ray energies when the energies are greater than about 10 MeV because the entrons of these gamma ray photons are extremely tiny. Therefore, low flux and very high-energy gammas pass through matter with almost zero attenuation. Photons with energies greater than about 10 MeV are in the Ross Model called “neutrino photons” or “neutrinos”. According to the Ross Model there is no such thing as the prior art neutrino (as described in the Background Section).

Gravity

According to this model very high-energy neutrino photons are released in black holes at the center of galaxies by the destruction of protons. Destruction of protons requires temperatures corresponding to photon energies in excess of 939 MeV, which is I estimate, about 400 billion times hotter than the surface of the sun. It is very hard to destroy a proton. When protons are destroyed, each proton releases three extremely high-energy entrons which adds heat energy to the black hole but many ultimately escape as 939 MeV neutrino photons. These neutrino photons from the destroyed protons stream out from the black hole to provide the gravity of the galaxy. These photons are extremely tiny with widths of about 6.6×10⁻¹⁶ m. Their entrons have diameters of about 1.23×10⁻¹⁷ m. Most pass right through objects such as stars and planets within the galaxy. The Coulomb forces of the two tronnies in each neutrino photon produce a reverse force on the charges in the stars and planets and everything else in the galaxy they pass through. This reverse force is directed back toward the source of the neutrino photons keeping these objects in their orbits in the galaxy. A small portion of the galaxy is sacrificed, actually pushed into the black hole, providing additional protons to be consumed to provide more neutrino photons to supply the galaxy its gravity. A portion of the neutrino photons from the black hole are temporally stopped in galactic objects (especially big ones) and later released in random directions giving the objects such as our sun, the planets including our earth and its moon their gravity. For all objects releasing neutrino photons the neutrino photon flux decreases as the inverse square of the distance from the object. This explains the object's gravity decreasing as the inverse square as explained by Isaac Newton.

### Einstein's Two Major Goofs

Special Relativity

A very important feature of the Ross Model is that the vacuum speed of light is not constant, but slows down or speeds up, when passing through a Coulombic reference frame, by an amount equal to the speed of the reference frame. For example, if a Coulombic reference frame, such as that of the earth, is moving through the universe at a speed of 0.1 percent c in a direction opposite the direction of a light beam, the light beam passing through the Coulombic reference frame will slow down to 99.9 percent c. If the reference frame is moving at a speed of 0.2 percent c in the same direction of a light beam passing through it, the light beam will speed up to a speed of 100.2 percent c. So that someone measuring the speed of light with equipment moving with the reference frame will measure the speed of light as the difference between (1) the speed of the frame and (2) the speed of light. In both cases the measured speed of light will be constant at c. Einstein's first major goof was to assume that the speed of light was constant based on the results of the Michelson—Morley experiments that showed that the “measured” speed of light is always constant. This explanation of light speed makes some of the most complicated features of the Special Theory of Relativity unnecessary.

General Rellativity

Einstein's second major goof was not to recognize that matter-penetrating photon neutrino photons are responsible for gravity. My discovery that neutrinos (my neutrinos, neutrino photons, not the prior art neutrinos) “carry” gravity makes most of the complicated features of General Relativity unnecessary if not wrong. Certainly, masses do not curve space. Space is merely the emptiness between things—it is nothing, you can't curve it. Space is also infinite in all three dimensions and there are only three dimensions: up and down, left and right and forward and backwards. Time is not a forth dimension; time is a measurable period between events. Time is absolute and is not affected in the least bit by how fast one is moving. My model brings logic back into science. If a fast train A is traveling east at 0.9 c and fast train B is traveling west toward train A on the same track at 0.9 c. People watching from train station C equidistance from the two trains, as well as people watching from each train will all conclude that the two trains are approaching each other at 1.8 c. If a galaxy is moving away from the earth at 0.9 C and a space ship is flying within the galaxy at a speed of 0.9 c relative to the center of the galaxy in the same direction that the galaxy is moving, that space ship is traveling at 1.8 c away from the earth.

### Uncertainty Principal

The prior art idea that uncertainty is a basic element of physics is wrong. There may be things going on that we have no way of measuring precisely, but the physics is completely precise. Coulombs law and its derivations apply to infinitely small dimensions and at all speeds. The fundamental particles in the universe are point particles so their position should be infinitely precise. Coulombs law is infinitely precise, at least as far as we know. Time is absolute. There is no limit to how many times you can divide a second. So the universe is infinitely precise. Currently, our instruments are not infinitely precise, but they are getting better and better.

### Momentum and Kinetic Energy

Momentum, mv, and kinetic energy, ½ mv², are relative concepts that are well known in the macroscopic world. Newton's laws of physics work very well in the macroscopic world. The laws however do not have a good foundation. Since according to my model the only fundamental force in the universe is the Coulomb force, Newton's laws should be a natural flow-down from the Coulomb forces.

### BRIEF DESCRIPTION OF THE DRAWINGS

FIG. 1 is a representation of a single tronnie pushed by its own force field. The speed of force field is the speed of light.

FIG. 2 shows the direction of attractive and repulsive forces acting in an entron.

FIGS. 2A, 2B and 2C show the positions of two tronnies making up an entron at three times during one period.

FIG. 2D shows Coulomb force fields at time t=0 T as shown in FIG. 2C. FIG. 2E shows positions, times and directions of Coulomb forces acting within an entron.

FIGS. 3A is a drawing showing a path of a photon.

FIGS. 3B is a depiction of a section of the photon path showing in detail an entron path.

FIG. 3C is a prior art graph of high energy photon attenuation.

FIG. 3D is a graph of electron speed as a function of captured entron energy.

FIG. 4 is a representation of a naked electron comprising three tronnies one plus and two minuses in a tripple tronnie twirl.

FIG. 4A is a side view of the FIG. 4 naked electron.

FIG. 4A(1)-4A(4) show the positions of tronnies in an electron at times t=0 and T, T/4, T/2, and 3T/4.

FIG. 4B is a drawing of an energetic electron.

FIG. 4B(1) shows an energetic electron with its captured entron.

FIG. 5 is a simple electric circuit.

FIG. 6 is a light emitting diode.

FIG. 7 represents a naked proton.

FIG. 8 is possible configurations of a neutron, a proton with an extra negatron driven by a high-energy entron.

FIG. 9 is a drawing of a deuteron.

FIG. 10 is a drawing of a tritium nucleus.

FIG. 11 is a drawing of an alpha particle.

FIGS. 12A through 12E depicts a melting crystal.

FIG. 13A through 13E describe types of magnetism

FIGS. 14A through 14E describe an example of exothermic chemistry.

FIG. 15 describes gravity.

### DETAILED DESCRIPTION OF THE PREFERRED EMBODIMENTS

### The Ross Model of the Universe

### Cast of Characters

In a preferred model of the universe, I have created two completely new terms and several old terms are given new definitions based on the preferred model. Therefore, I begin this detailed description with the following definitions that may be referred back to from time to tine by the reader:

Tronnie A mass-less volume-less point particle (a “pointicle”) having a charge of plus or minus e, where e is the magnitude of the electron charge, about 1.6×10⁻¹⁹ coulomb. The tronnie is only elementary particle in the Universe and the Coulomb forces associated with its charge are the only forces in the Universe. Tronnies produce Coulomb force fields that travel out from the tronnies at the speed of light. Unlike tronnies attract each other and like tronnies repel each other. Individual tronnies repel themselves so tronnies always travel as fast or faster than the speed of light. Tronnies almost always travel in circles in association with one or more tronnies where the forces acting between the tronnies are continuous and integrated.

Entron A combination of a plus tronnie and a minus tronnie with each tronnie traveling at speeds of 1.57 c in a circle. This is the basic quantum of energy. An entron is a constituent part of eVery photon and entrons are the energy of every high-energy electron. Three very high energy entrons are constituent parts of each proton and account for almost all of the proton's mass. Additional entrons may also form parts of atoms and molecules. Other lower energy entrons trapped in matter define its heat and temperature. The diameter d′ of the path of the tronnies within the entron is d′=λ/160.64, where λ corresponds to the photon wavelength of a photon the entron is a part of or the photon the entron would create if it were released as a photon from a particle it is a part of or matter in which it is trapped. The entron mass is one-third of the photon energy so mₑₙₜᵣₒₙ=hc/3λ=hf/3. The net charge of an entron is zero.

Photon A photon is comprised of one circling entron, with the circling entron itself traveling in a looping path. The looping path is the result of the entron following a loopy path within the photon's path which is λ/2 wide at a speed of 1.57 c, where λ is the photon's wavelength and c is the speed o light The photon's path is a straight line. The net charge of a photon like the entron is zero; its total energy is the entron energy, hc/λ and its mass is equivalent to one-third of its total energy. Its kineticenergy is equal to ½ mv² where v is the average velocity of the entron, i.e. 2 c.

Neutrino A neutrino is a very high energy photon with wavelengths shorter than wavelengths prior art gamma rays. So a photon with energies in excess of 20 MeV would be a neutrino photon. Very high energy neutrinos are produced in black holes as a consequence of the destruction of protons. They travel at the speed of light and easily penetrate matter. Neutrinos from the black hole in the center of galaxies radiate out with fluxes equal to the inverse square of distance from the black hole. Most neutrinos pass through the objects they illuminate including massive stars. Many are temporally trapped in stars, planets and moons and then later radiate out from these objects with fluxes decreasing as the inverse square of distance from the objects. The tronnies in the neutrino produce Coulomb force fields that travel backward (at the same speed that the neutrino is traveling forward) toward the source of the neutrinos producing a backward force on the matter through which the neutrinos are passing. This force is the gravitational force. Neutrinos from the black hole in the center of our galaxy hold the sun and all of the stars of the galaxy in their galactic orbits. Neutrinos from the sun hold the earth in its orbit. Some neutrinos are trapped in the earth and later released providing the earth with its gravity holding us to its surface. I propose a dividing line between neutrino photons and gamma ray photons to be: (1) gamma ray photons apply a repulsive force on masses they illuminate and (2) neutrino photons apply an attractive force on masses they illuminate.

Electron An electron is a combination of three circling tronnies. There are two types of electrons: (1) negatrons, each with a net charge of −e and (2) positrons, each with a net charge of +e. In the negatron a plus tronnie travels at a very high frequency (very short period) in a tight circle with two minus tronnies circling the path of the plus tronnie one-forth period behind the plus tronnie. In the positron a minus tronnie travels at a very high frequency (very short period) in a tight circle with two plus tronnies circling the path of the minus tronnie one-forth period behind the minus tronnie. A negatron-positron pair is produced in a process called “pair production” by the combination of the six tronnies from the entron parts of three gamma ray photons. “Naked” electrons and “naked” positrons are self-propelled at a velocity of 2.18×10⁶ m/s giving them a “naked kinetic energy” (½)(mv²) of about 13.5 electron volts. Naked electrons and naked positrons capture low energy entrons to slow down, but the capture of entrons with energies exceeding 13.5 eV will drive them in directions opposite their natural direction. The capture of entrons by conduction electrons gives the electrons their electric potential. The capture of a 13.5 eV entron will reduce the velocity of the electron from 2.18×10⁶ m/s to about zero but will give it a potential of 13.5 eV. The capture of a 300 MeV entron by an electron will drive the electron to speeds of about 0.99999 times the speed of light.

Proton A proton is a combination of three very high-energy electrons, one very high-energy negatron (the negative electron) and two very high-energy positrons (positive electrons). Each of the high-energy electrons has captured the entron part of a neutrino photon increasing the electron mass several hundred times so that the mass of the proton is about 1800 times the mass of an electron. Eight plus tronnies and seven minus tronnies (the nine tronnies from two positrons, one negatron plus the six tronnies from the entrons of three neutrino photons) in the proton give it a net charge of plus 1e. An anti-proton is the anti-particle of the proton.

Neutron A neutron is a proton plus and circling negatron driven by a gamma ray entron at a speed of about one percent of the speed of light. The neutron has a net charge of zero.

### Tronnies

Tronnie Model

FIG. 1 is a drawing of a single negative tronnie 80. It is a point. It has no mass and no volume, it possesses only a negative charge (−e) and the Coulomb force associated with its negative charge. This Coulomb force is in the form of a force field that proceeds out from the tronnie 80 in spheres 82 expanding at the speed of light. Tronnie 80 is being pushed out by its own Coulomb force fields as shown in FIG. 1. The space between the expanding circles represent a fixed time period such as a nanosecond or a second and a corresponding distance. If the time period is a second, then the distance is 300 million meters! If the time period is one billionth of a second then the distance is about a foot. If the time period is a billionth of a billionth of a second (10⁻¹⁸ second), the distance is atomic size (3×10⁻¹⁰ m). Three of nine circles expanding out from the location of tronnie 80 nine time intervals in the past are shown at 82. Tronnies are very little (infinitely small) and very fast (never slower than the speed of light) and they are usually combined in dynamic equilibrium with at least one other tronnie, which may be why we have lived with them for so long without ever recognizing them.

If the tronnie is not tied to one or more other tronnies in some sort of association, it may travel through sections of the universe along routes that seem random being pushed and pulled by other Coulomb forces everywhere present in the universe. Since tronnies of opposite sign attract each other, they tend to pair up into configurations (entrons) of circling pairs of opposite tronnies with each tronnie diametrically opposed to its mate.

### Tronnies are Suggested by Coulomb's Law

Coulomb's Law says that the force between two charges is proportional to the product of the charges and inversely proportional to the square of the distance between them. At distances infinitely close to zero, the Coulomb force approaches infinite. A consequence of this law is that elementary charged particles must be point charges with no volume or any other dimension. Otherwise, the elementary charged particle would blow itself apart with infinite or near infinite force. It is obvious that a point cannot have mass. Infinite density makes no sense. Therefore, all charged particles must be charged point particles or be made up of charged point particles. This is the essence of the Ross Model. The question is: “Could an elementary charged point particle travel at speeds less than the speed of light.” The answer is “No”. The Coulomb force on a charge A from a like charge A′ is felt by A based on the position of A′ when the force (traveling at the speed of light and reaching A) left A′. Therefore, if a mass-less point charge ever attained a speed equal to or greater than the speed of light, forces from its own past would assure that it never slowed down to a speed of less than the speed of light. I believe no tronnie ever traveled more slowly than the speed of light but if it did the Coulomb forces from two nearby like charges (each pushing the particle at the speed of light) would drive the mass-less point particle away at speeds greater than the speed of light. Once it is going away from a past position of itself faster than the speed of light its own past (especially its immediate past) will keep it going at at least the speed of light. Therefore, we can assert that every elementary charged particle in the universe must be a mass-less point particle doomed to always travel at speeds equal to or greater than the speed of light.

Examples of Things Made from Tronnies

According to preferred embodiments of this invention, everything in the universe is made from tronnies. This application describes and claims processes for describing and explaining elements of the universe based on this model. Thus, all elements of the universe are comprised of only these mass-less, volume-less point particles (we could more properly call them “pointicles”) with their charge of either plus e or minus e. Specific examples of things that are described and explained in this Application by this process include: entrons (a new thing, unknown in the prior art), photons, radio waves, neutrinos (my neutrinos not the prior art neutrinos), electrons (positrons and negatrons), energetic electrons, electric current, protons and neutrons, atoms, heat and temperature, magnetism, chemical energy, fission and fusion, gravity, black holes, receding galaxies and the beginning and the end of the universe.

### Entrons

Tronnie Pairs

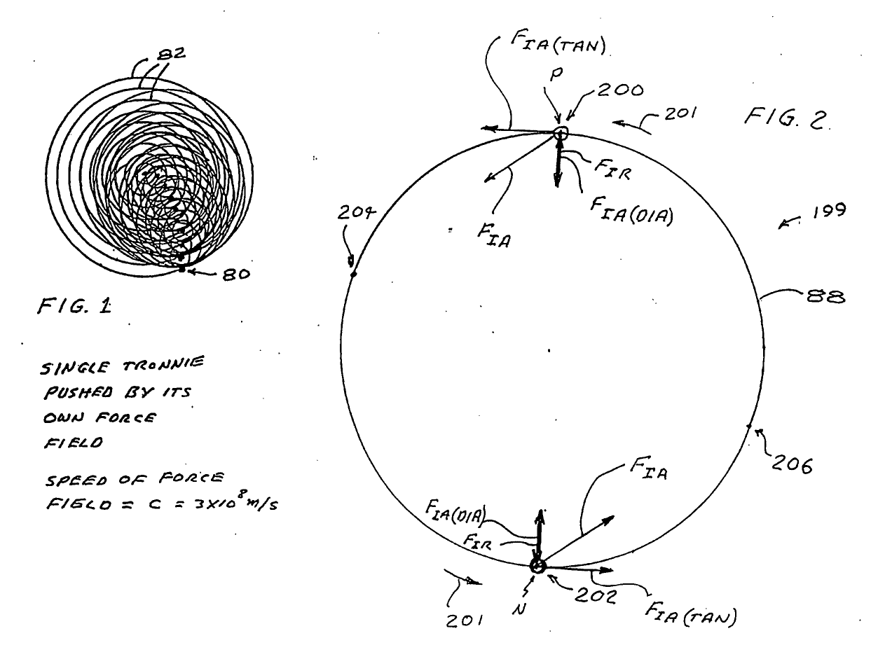

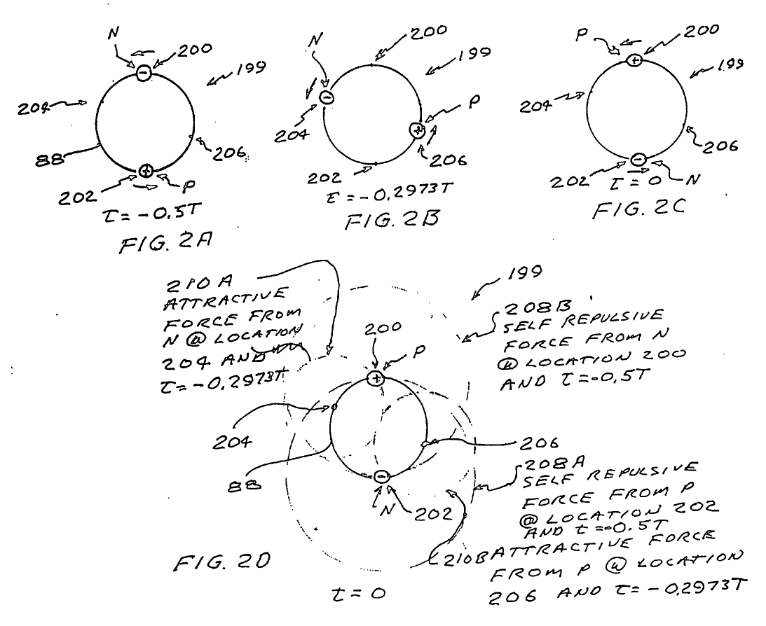

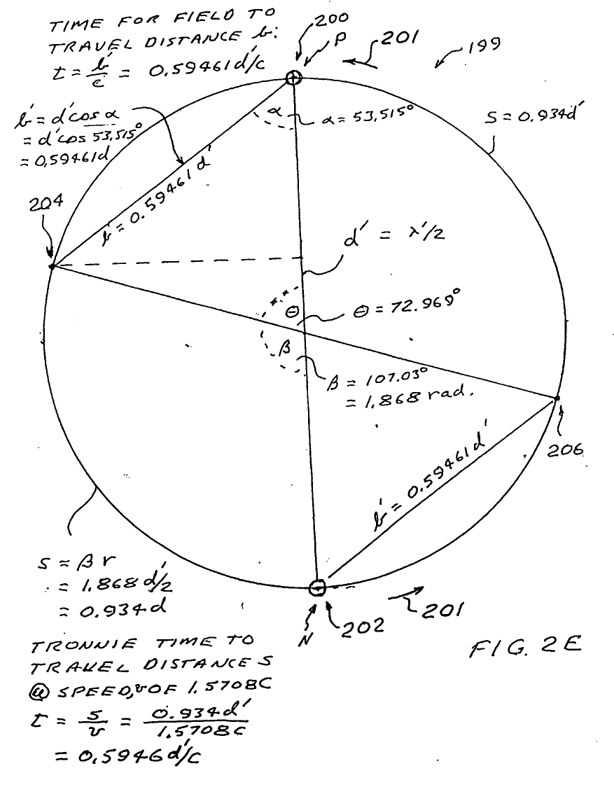

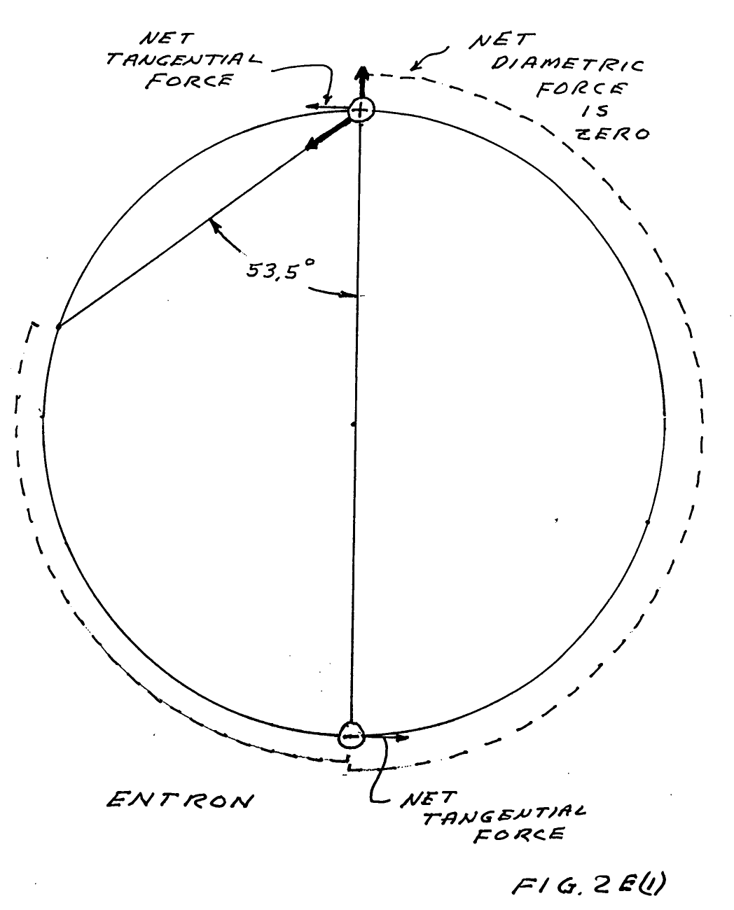

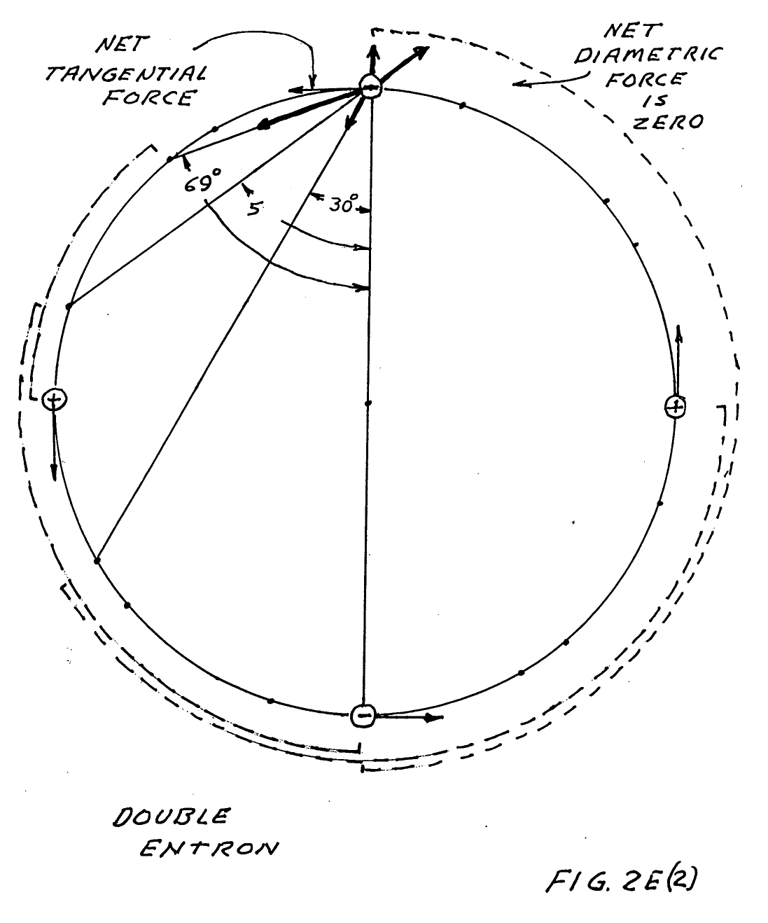

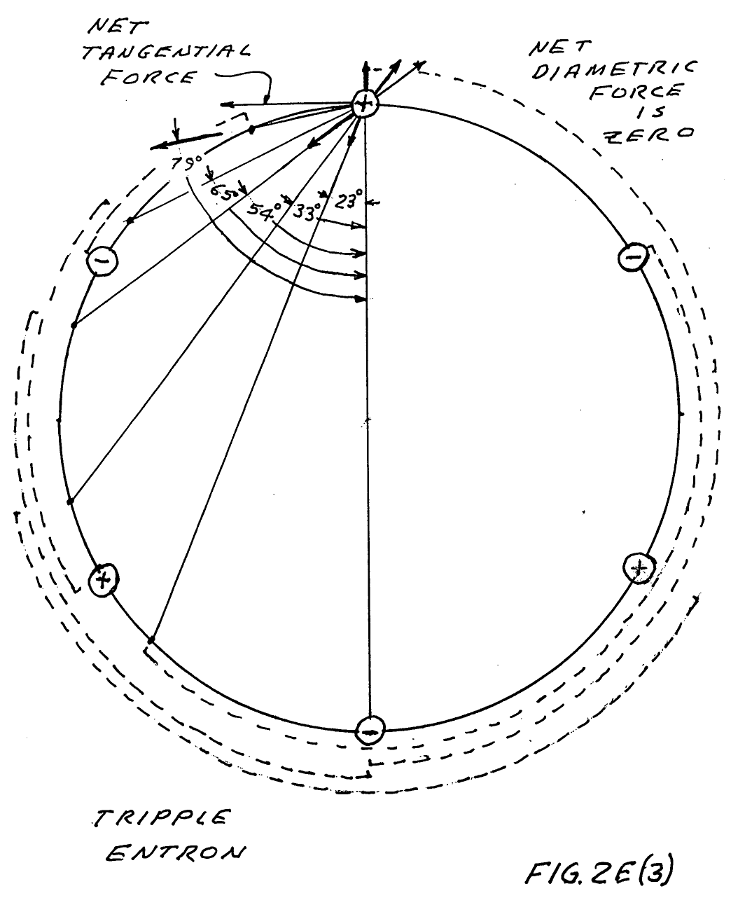

FIG. 2 is a drawing of two tronnies in a stable configuration to produce energy and its equivalent mass. A plus tronnie P and a minus tronnie N have joined together in a mutual-attraction-self-repulsion orbit along circular path 88 in circular direction 201. The diameter of the circle is d′ and this diameter d′ defines an entron wavelength λ′, as d′=λ′/2, as shown in FIG. 2E. The period of the orbit is T′=1/f′=λ′/c, where f′ is the frequency of the tronnie orbit in entron 199, and c is the speed of light. The wavelength λ′ could be any length. For example if λ′ is 1×10⁻⁸ m (which is the approximate wavelength of an entron λ′ in a green light photon with a photon wavelength λ of 0.54 microns, 5.4×10⁻⁷ m), then T′ would be about 3.3×10⁻¹⁷ second. Plus tronnie P in FIG. 2 is located at the position designated 200 at time, t=0. At time t=−0.5 T′ (t=−0.5×10⁻¹⁷ second) plus tronnie P was located at the position 202 on the opposite side of circle 88. Minus tronnie N is located at position 202 at time, t=0. At time t=−0.5 T′ minus tronnie N was located at the position 200 on the opposite side of circle 88. At time t=about −0.3 T′ plus tronnie P was located at position 206 and minus tronnie N was located at position 204. The forces on tronnies P and N are shown by arrows F_{IA}, F_{IR}, F_{IA(DIA)} and F_{IA(TAN)}. Thus, for this typical green light entron, repulsive and attractive Coulomb forces keep these two tronnies directed around the circle at a frequency of 3×10¹⁶/second (thirty million billion times per second!). A quantitative discussion of these forces is provided in the following section.

Entron Model

Entron 199 is depicted in FIGS. 2 and 2A through 2E. Three snap shots are shown in FIGS. 2A, 2B and 2C, respectively representing the positions of the two tronnies in entron 199 at t=−0.5 T′, t=−0.2973 T′ and t=0, where T′ is one period of oscillation of entron 199. In FIG. 2C the plus tronnie P is shown at location 200 and minus tronnie N is shown at location 202 at t=0. Both tronnies travel around circle 88 at a speed of πc/2 (1.57 c=4.71×10⁸ m/s). Their Coulomb forces travel at speeds of c (3×10⁸ m/s), so each tronnie is repelled by it own Coulomb force emanating from itself when it was on the diametrically opposite side of the circle. For example, plus tronnie P at location 200 at t=0 feels the repulsive force emanating from itself at t=−0.5 T′ when it was located at location 202 as shown in FIG. 2A. In addition each tronnie is attracted by the other tronnie. For example, plus tronnie P at t=0 feels the attractive force of minus tronnie N emanating from minus tronnie N when minus tronnie N was located at location 204 at t=−0.2973 T as shown in FIG. 2B. Likewise, minus tronnie N feels the repulsive Coulomb force that emanated from itself at t=−0.5 T′ and the attractive force of plus tronnie P when plus tronnie P was located at position 206 at t=−0.2973 T′. The positions of these force fields at t=0 are shown as circles in FIG. 2D. The repulsive force fields are identified as 208A and 208B and the attractive force fields are shown at 210A and 210B.

Integrated Coulomb Force—Energy/Mass

We can calculate these forces. The well-known Coulomb force is:
F_{I}=q₁q₂/4πεd²=2.3×10⁻²⁸ Nm²/d² (1)
since ¼πε=9.0×10⁹ Nm²/C² and q₁ and q₂ each equal 1.6×10⁻¹⁹ C. The distance separating the charges is d. We integrate this force (with units of Newtons) from infinity (where it is zero) to d to get an integrated force F_{I}:
F_{I}=2.3×10⁻²⁸ Nm²/d (2)

The reader should note that since d is in meters, the integrated force F, has units of energy (i.e. Newton-meters or Joules), so
F_{I}=Eₑₙₜᵣₒₙ=2.3×10⁻²⁸ Jm/d

Mass and energy can be equated according to E=mc², so:
F_{I}=mₑₙₜᵣₒₙ=(2.3×10⁻²⁸ Jm/d)/8.99×10¹⁶ J/kg=2.33×10⁻⁴⁵ kg-m/d.

So by reference to FIG. 2E, lets look at the integrated forces on tronnie P. Let the diameter of the orbit circle be d′ so from equation )2) the repulsive integrated force FIR that tronnie P feels at location 200 at time t=0 from its own repulsive force field originating on the diametrically opposite side of the circle (i.e., from location 202 at time t=−0.5 T′) is:
F_{IR}=2.3×10⁻²⁸ Nm²/d (3)

The attractive force from minus tronnie N felt by plus tronnie P at time zero depends only on the location of minus tronnie N when the Coulomb force wave which intersects plus tronnie P at time t=0 left minus tronnie N at time t=−0.2973 T′. I have determined that position to be a point on the circumference of the circle such that angle β as shown in FIG. 2E is 107.03 degrees (1.868 radians). This position is the only position from which the force field 210A could leave minus tronnie N if it is to intersect the path of plus tronnie P at location 200 at the same time as minus tronnie N arrives at location 202.

The time required for minus tronnie N to travel from location 204 to its location 202 at time t=0 at a speed of 1.57 c is exactly the same as the time required for its force field 210A (as shown in FIG. 2D) to travel from location 204 to location 200 where it intersects plus tronnie P at time t=0. This is all demonstrated by the following timing calculation:

Timing Calculation

As shown in FIG. 2E the circumferential path S of minus tronnie N from location 204 to location 202 is:
S=βr=1.868 d′/2=0.934 d′ (4)
where β is 107.03 degrees but in radians β=1.868 and r=d′/2.

Tronnie N travels at a speed of cπ/2 (i.e., 1.5708 c) so the time for N to make the journey for 204 to 202 is:
t₁=s/v=0.934 d′/1.7708 c=0.5946 d′/c (5)

The distance b that force field 210A must travel from location 204 to intesect plus tronnie P at location 200 is:
b=d′cosα=d′cos 53.515 degrees=0.5946 d′ (6)

The force field 210A travels at the speed of light c so the time required for the force field 210A to travel from location 204 to location 200 (as shown in FIG. 2D and FIG. 2E is:
t₂=b/c=0.5946 d′/c (7)
so t₁=t₂
Attractive Force Calculation

The distance b from location 204 to location 200 is b=0.5946 d; therefore, the attractive integrated force (F_{IA}) from force field 210A on plus tronnie P at location 200 is:
F_{IA}=2.3×10⁻²⁸ Nm²/0.5946 d′=3.868×10⁻²⁸ Nm²/d′. (8)

Now this force is directed at an angle α=53.515 degrees, with respect to the repulsive force field produced by force field 208A. So we break the integrated attractive force into two components a diametrical component in the direction of diameter d toward location 202 and a tangential component perpendicular to the diametrical component.

The Diametrical Integrated Force Component

The diametrical component of the attractive integrated force F_{1A(DIA}) is:
F_{1A(DIA})=F_{IA}cos α=3.868×10⁻²⁸ Nm²/d′ cos 53.515 degrees=2.3×10⁻²⁸ Nm²/d′. (9)

Comparing the results of Equations (3) and (9), the diametrical attractive force F_{1A(DIA}) from field 210A (as shown in FIG. 2D) on plus tronnie P exactly balances the integrated repulsive force F_{IR} from force field 208A (also as shown in FIG. 2D).

The Tangential Integrated Force

The tangential component of the attractive integrated force F_{IA(TAN)} is:

$$\begin{matrix}{F}_{1 A ( TAN )} = {F}_{1 A} sin α \\ = {F}_{1 A} sin 53.515 degrees \\ = ( 3.868 \times {10}^{- 28} ) ( 0.804 ) / {d}^{′} \\ = 3.11 \times {10}^{- 28} {Nm}^{2} / {d}^{′}\end{matrix} \qquad ( 10 )$$

The tangential component we have just calculated for plus tronnie P is matched by an equal tangential component for minus tronnie N all as shown in FIG. 2. So that the total tangential integrated forces causing entron 199 to spin in the direction shown at 201 is double the value calculated above. Therefore, the integrated net forces F_{IN} operating within entron 199 are tangential and equal to:
F_{IN}=2×F_{1A(TAN)}=6.22×10⁻²⁸ Nm²/d′ (11)

The units of this parameter are those of energy (i.e., Newton-meters or Joules). These forces are causing the two tronnies to circle in its frame of reference. Where neither tronnie on its own could resist any force, together they provide a resistance to outside forces,. This is mass! (We can convert to mass units by dividing 6.22×10⁻²⁸ Nm²/d′ by c², 9×10¹⁶ m²/s²) We have just created mass from two things (tronnies) without mass. So we say that the entron has mass. Since that mass can be converted into energy, we say the entron has mass/energy. And that mass/energy, m/e, is equal to:
F_{IN}=m/e=6.22×10⁻²⁸ Nm²/d′ (in energy units—Joules) and (12)
m/e=6.9×10⁻⁴⁵ kgm/d′ (in mass units—kilograms). (13)

So let's call this value of FIN, the integrated forces, the entron mass/energy “m/eₑₙₜᵣₒₙ” or the entron mass “mₑₙₜᵣₒₙ”.

Relating the Size of the Entron to the Wavelength of the Photon

Now we know that the energy of a Photon is:
Eₚₕₒₜₒₙ=hc/λ

Where h is Planck's constant=6.626×10⁻³⁴ Nms and
c is the speed of light=3×10⁸ m/s, so
   Eₚₕₒₜₒₙ=hc/λ=1.99×10⁻²⁵ Nm²/λ

According to my preferred model of the photon two-thirds of the photon energy is kinetic energy and one-third represents the mass-energy of the photon. Now we speculate that the photon energy that we measure (i.e., 1.99×10⁻²⁵ Nm²/λ) is the total photon energy and that the mass-energy of the entron (which is the same as the mass of the photon it is a component of) is one-third of that or 6.6333×10⁻²⁶ Nm²/λ. So:
mₑₙₜᵣₒₙ=mₚₕₒₜₒₙ=Eₚₕₒₜₒₙ/3=(1.99×10⁻²⁵ Nm²/λ)/3=6.633×10⁻²⁶ Nm²/λ. (14)

Equation (14) is in energy units. We combine equation (12) and equation (14) to determine the diameter of the entron in terms of the wavelength of the photon that it is a part of:
mₑₙₜᵣₒₙ=mₚₕₒₜₒₙ 6.22×10⁻²⁸ Nm²/d′=663.333×10⁻²⁸ Nm²/λ,
so the diameter d′ of the entron is:
d′=0.009377λ=λ106.64 (15)
where λ is the wavelength of the photon. The entron wavelength λ′ is 2d′ so:
λ′=2d′=λ/53.32 (16)

The time for the Coulomb force fields 208A and 208B (see FIG. 2D) to travel across the entron is t=d/c which is one-half the entron's period, so the entron's period would be:
Tₑₙₜᵣₒₙ=2d′/c=λ53.32c=Tₚₕₒₜₒₙ/53.32 (17)

And the frequency of the entron, fₑₙₜᵣₒₙ is:
fₑₙₜᵣₒₙ=53.32fₚₕₒₜₒₙ (18)

Let's define a wavelength for the entron, λₑₙₜᵣₒₙ, as twice its diameter so:
λₑₙₜᵣₒₙ=2dₑₙₜᵣₒₙ=λₚₕₒₜₒₙ/53.32 (19)

Letting λ, f, T, d and E refer to the wavelength, frequency, period, diameter and energy of photons and λ′, f′, T′, d′ and E′ refer to the wavelength, frequency, period, diameter and energy of entrons:
T′=T/53.32
f′=53.32f
λ′=λ/53,32
T′=1/f′
f′=1/T′
λ′=c/f′=2d′
d′=λ′/2=d/53.3=λ/106.64
E′=E=hc/λ=hc/106.64λ′
   Net Integrated Forces Equal Entron Mass/Energy

In summary, the energy of an entron in terms of the wavelength of a photon the entron is a part of is equal to the net integrated Coulomb forces of the entron. The diametrical forces cancel leaving only the tangential components of the attractive integrated forces F_{IA(TAN)} as shown in FIG. 2E causing entron 199 to rotate. Those two attractive integrated tangential forces are:
F_{IA(TAN)}=2(2.3×10⁻²⁸ Nm²/b′)sinα
F_{IA(TAN)}=2[(2.3×10⁻²⁸ Nm²/0.5946d′)] sinα
F_{IA(TAN)}=2[(2.3×10⁻²⁸ Nm²/(0.5946)(λ/106.6)]0.804
F_{IA(TAN)}=0.663×10⁻²⁵ Nm²/λ, (20)
where distances b′ and d′ and angle α are shown in FIG. 2E and λ is the photon wavelength. The resulting integrated tangential force 0.663×10⁻²⁵ Nm²/λ is equal to one third of the photon energy (i.e. Eₚₕₒₜₒₙ=hc/λ)=1.99×⁻²⁵ Nm²/λ). That is:
F_{IA(TAN)}=0.663×10⁻²⁵ Nm²/λ=Eₚₕₒₜₒₙ/3=(hc/λ)/3=(1.99×10⁻²⁵ Nm²/λ)3
Formation of an Entron

A potential problem with this “tronnie” theory is that if these plus and minus tronnies have opposite charges and no mass, why don't they attract each other, combine and disappear (as do positrons and negatrons)? I believe that tronnies neVer combine to annihilate each other. The reason is that each tronnie is repelled by itself at speeds equal to or greater than the speed of light. If a tronnie is riding in a straight line on its own Coulomb force wave, the repelling force is infinite, continuous and always greater than any attractive force. Any attractive force from another tronnie cannot be continuous unless the two tronnies are traveling together in some kind of pattern, such as a circle (see FIG. 2D, for example). Two tronnies approaching each other (at the speed of light or greater) merely pass each other and fly off in opposite directions each feels significant attractive force from the other for only an extremely short time interval. HoweVer, if billions of tronnies are confined to a small space, unpaired plus and minus tronnies will quickly be forced into circles with diameters of various lengths (see FIGS. 2 and 2A-F). These circling tronnies pair up into entrons. Entrons can leave a space by radiation or conduction. The energy of these entrons in either case is E=hc/λ or hc/53.3λ′, where h is Planck's constant, λ is the photon's wavelength and λ′ is the entron's wavelength (λ′=λ53.3) and c is the speed of light. Once an entron is formed, especially a high-energy entron, it can exist in its condition for billions of years. We can look up and see photons from galaxies billions of light years distant that have been flying through our universe unchanged for those billions of years.

### PHOTONS

Photon Model

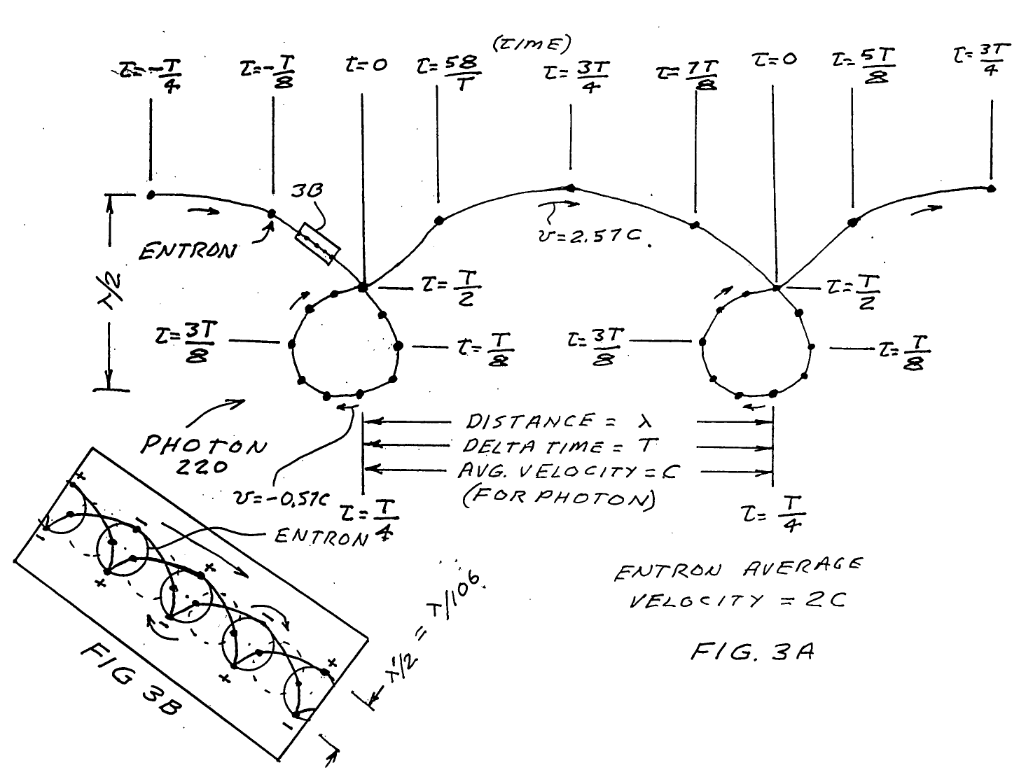

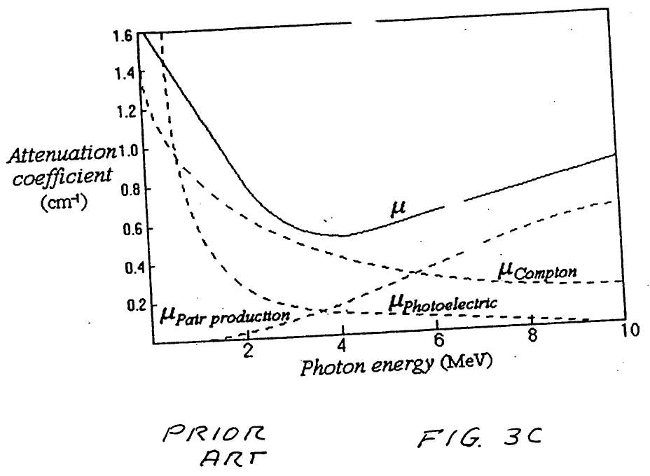

My latest photon model is shown in FIGS. 3A, 3B and 3C. This model is based on my conclusion that an entron is an integral mass/energy part of eVery photon. The two tronnies of the entron in a photon follow a circular path in the reference frame of the entron and the entron (and its reference frame) follows an approximately circular path in the reference frame of the photon (which in our reference frame is moving in a straight line at the speed of light). The width d of the photon path is 53.3 times larger than the diameter d′ of the entron circle (d=53.3d′ as explained above).

FIG. 3A is a drawing of the photon showing how it would appear in a frame of reference through which the photon is moving at the speed of light as indicated by arrow 119. In this frame of reference entron 199 is shown small in FIG. 3A compared to the photon and is shown enlarged in FIG. 3B. As shown in FIGS. 3A and 3B, the width of the photon is λ/2 and the diameter of the entron circle is λ′/2. As explained above, λ is the wavelength of the photon and λ′ is the wavelength of the entron and λ′=λ/53.3.) Entron 199 as shown in FIG. 3B is comprised of only plus tronnie P and minus tronnie N and photon 220 (shown in FIG. 3A) is comprised of only entron 199. If you prefer photon 220 is also comprised of only plus tronnie P and minus tronnie N which are shown at two voluneless points at 199 in FIG. 3A. (I will digress here for a second to point out again that everything in the universe is comprised on nothing but plus tronnies P's and minus tronnies N's.) Entron 199 is moving in an approximately circular path 201 and is also moving in the photon direction at a speed of c. (So its speed in our reference frame varies from about minius 0.57c to about 2.57c.) The two tronnies making up entron 199 are moving even faster than the entron itself, since they are also moving at speeds of 1.57c in the entron's frame of reference along an approximately circular path as shown in FIG. 2.

Why Entrons Form Themselves into Photons

The reader may ask why entrons, once free from the matter that they had been heating up or otherwise exciting, don't shoot off at the speed of light in a straight line. The answer, according to this preferred model, is that the entron tries to shoot off at the speed of light in a straight line but is forced into a looping path 53.3 times wider than the entron diameter. An entron pushing itself through space is forced to travel in looping circles having a diameter of λ′/2 along a curved path as shown in FIG. 3B that that produces another set of looping circles defining a photon as shown in FIG. 3A (photon reference frame) and having a diameter of λ/2, where λ=53.3λ′. As explained above an entron's normal configuration is two opposite tronnies traveling at 1.57c on opposite sides of a circle or diameter 80 ′/2. Its own Coulomb forces can drive the entron (the rotating tronnie combination) away faster than the speed of light along a curved path. In FIG. 3B, the two tronnies are circling at 1.57c in the entron's reference frame but the entron itself is following a looping path within the photon that is traveling at the speed of light. Note that the separation of the two tronnies is always λ/2 and during portions of each loop each of the tronnies are traveling in a backward direction. Also, note that for almost the entire path the tronnies are traveling in our reference frame much faster than the speed of light. HoweVer for a short period the tronnies along this path would be traveling more slowly than the speed of light, which is impossible. (The actual speed would be the sum of plus c and minus 1.57c that would be minus 0.57c. That is slower than the speed of light. Therefore, according to a preferred model, the tronnies travel backwards at a speed of c instead of 0.57c.) The result is that the path of the entron must be curved. The curvature I am proposing is that which would cause the entron to make a complete loop in 53.3 cycles of itself as it moves forward in the photon direction as a part of its photon. The reader may want to know how I came up with 53.3. The answer is that if the entron is smaller than the photon by a ratio 1/53.3; the net integrated Coulombic forces in the photon′ entron is equal to one-third of the energy of the photon [(Eₚₕₒₜₒₙ)/³=(hc/λ)/3 or hf/3] as explained in the above section entitled, “The Tangential Integrated Force” and equation (16). (I will digress again by stating that the 53.3 ratio may be wrong. In earlier papers I have proposed a ration of 160. However, at least for the time being I am sticking with 53.3 and reserve the right to change it if a better analysis comes along.)

FIG. 3A (referred to above) is a drawing of the path 220(A) of photon 220 by someone watching it pass by from a stationary frame of reference. FIG. 3A shows two wavelengths λ of the photon's path (from −T/4 to +3T/4). The reader will note the path made by the photon is similar to the path made by a spot on the rim of a wagon wheel rolling across the prairie. HoweVer, for the analogy to be closer the wagon wheel would need to be rotating 1.57 times faster than ordinary wagon wheels. Where the spot meets the prairie, the spot would be traveling in reVerse instead of being stationary. Also, the bottom loop of the entron's path bulges toward the rear in order for the entron to stay in front of its Coulomb force wave as it makes the loop at the bottom of its path. The entron makes 53.3 revolutions during each photon cycle. About five of these entron revolutions are shown in FIG. 3B (in the photon's reference frame). FIG. 3B is an enlargement of a portion 3B of FIG. 3A. The looping paths of the two tronnies should now be clear to the reader. Note that in this frame of reference the entron itself (made up of the two tronnies) speeds up and slows down (actually traveling backwards) during parts of each photon cycle. But there are no forces on the tronnies trying to slow them down to less than the speed of light. Therefore, the photon unlike the entron can travel through the universe in a straight line. Based on this model, the two tronnies making up an entron are always separated from each other by a constant distance, λ/2.

The Size of Typical Photons and Entrons

This preferred model proposes an entron diameter of λ/06.6 where λ is the wavelength of the photon that the entron is a part of. And the width of the photon path is λ/2. So we can visualize the size and energy of some photons we are familiar with. The following table lists some typical photons and their entrons by their wavelengths, energies and diameters or widths.

TABLE I

| | Photon | Entron-Photon | Entron | Photon | Entron-Photon | Entron-Photon |
|---|---|---|---|---|---|---|
| | Wavelength | Energy | Diameter | Width | Energy | Mass |
| Photon | (m) | (eV) | (m) | (m) | (J) | (Kg) |
| Radio Wave | 1.24 × 10³ | 1 × 10⁻⁸ | 1.16 × 10 | 0.62 × 10³ | 1.6 × 10⁻²⁸ | 6.7 × 10⁻⁴⁶ |
| Microwave (oven) | 1.21 | 1.013 × 10⁻⁶ | 1.14 × 10⁻² | 6.05 × 10⁻¹ | 1.62 × 10⁻²⁴ | 6.02 × 10⁻⁴² |
| 75 GHz mm wav | 4 × 10⁻³ | 3.07 × 10⁻⁴ | 3.75 × 10⁻⁵ | 2 × 10⁻³ | 4.96 × 10⁻²³ | 1.8 × 10⁻⁴⁰ |
| Near IR Photon | 1 × 10⁻⁵ | 1.24 × 10⁻¹ | 9.38 × 10⁻⁸ | 5 × 10⁻⁶ | 1.98 × 10⁻²⁰ | 7.3 × 10⁻³⁸ |
| Green Light Photon | 5.4 × 10⁻⁷ | 2.29 | 5.06 × 10⁻⁹ | 2.7 × 10⁻⁷ | 3.68 × 10⁻¹⁹ | 1.33 × 10⁻³⁶ |
| 13.5 eV ultraviolet | 9.18 × 10⁻⁸ | 1.35 × 10 | 8.66 × 10⁻¹⁰ | 4.59 × 10⁻⁸ | 2.16 × 10⁻¹⁸ | 8.0 × 10⁻³⁶ |
| X-Ray | 1 × 10⁻¹⁰ | 1.24 × 10⁴ | 9.38 × 10⁻¹³ | 5 × 10⁻¹¹ | 1.97 × 10⁻¹⁵ | 7.3 × 10⁻³³ |
| Gamma (0.74 MeV) | 1.66 × 10⁻¹² | 7.4 × 10⁵ | 1.56 × 10⁻¹⁴ | 8.3 × 10⁻¹³ | 1.19 × 10⁻¹³ | 4.4 × 10⁻³¹ |
| Gamma (1.02 MeV) | 1.23 × 10⁻¹² | 1.02 × 10⁶ | 1.15 × 10⁻¹⁴ | 6.15 × 10⁻¹³ | 1.63 × 10⁻¹³ | 6.04 × 10⁻³¹ |
| Gamma (7 MeV) | 1.76 × 10⁻¹³ | 7 × 10⁶ | 1.65 × 10⁻¹⁵ | 8.8 × 10⁻¹⁴ | 1.13 × 10⁻¹² | 4.19 × 10⁻³⁰ |
| Neutrino (939 MeV) | 1.32 × 10⁻¹⁵ | 9.39 × 10⁸ | 1.23 × 10⁻¹⁷ | 6.6 × 10⁻¹⁶ | 1.5 × 10⁻¹⁰ | 5.5 × 10⁻²⁸ |

Table I can be extended to photons with other wavelengths using the following relationships:

Entron-Photon Energy: E=hc/λ=(4.136×10⁻¹⁵ eVs)3×10⁸ m/s/λ=(6.626×10⁻³⁴ Js)3×10⁸ m/s/λ

Entron Diameter: d′=λ/106.6

Photon Width: d=λ/2

Entron-Photon Mass: m=E/(3)(9×10¹⁶ m²/s²)

Table I demonstrates the tremendous range of photons. I will give a brief description of the examples I have listed:
The radio wave example is a big photon its wavelength is a kilometer.
The photons that heat our TV dinners in our microwave ovens have wavelengths of 1.2 meters and entrons with diameters a little larger than a centimeter (too large to squeeze through the metal grid in the oven window).
To cool off we radiate photons from our warm 98.6° F. bodies at wavelengths in the range of about 4 millimeters.
Infrared radiation at wavelengths of about 10 microns (with entron diameters of about 0.1 microns) are a little too long for our eyes to detect.
But our eyes are extremely sensitive to green visible light photons at wavelengths of 0.54 microns with entron diameters about the size of molecules in our retinas.
The 13.5 eV entron of the ultraviolet photon with entron diameters about the size of atoms is needed to slow down naked electrons to zero velocity, but these photons are too small for our eyes to detect.
The 12.4 keV x-ray photon example has a wavelengths of 0.1 nanometers and its entron diameter at about 10-12 m is a lot smaller than atoms and a lot larger than atomic nuclei, which may explains why x-rays come from atoms and not nuclei.
The 0.74 MeV gamma ray photon with an entron diameter a little larger than the proton is released when a neutron decays to a proton with the release of an electron.
The 1.02 MeV gamma ray photon is the minimum energy photon that can participate in pair production. It takes three of these to make a pair of electrons.
The 7 MeV gamma is captured by a proton to slow it down enough for it to become a hydrogen nucleus. Its entron is a little larger than a proton, but smaller than most atomic nuclei. The photon is released in the hydrogen to helium fusion process.
Lastly, the 939 MeV neutrino photon is a most important photon. Its entron has a diameter of 1.23×10⁻¹⁷, about 100 times smaller than a proton. Three of these entrons provide a proton with almost all of its mass and according to the Ross Model, these photons are be released in black holes when protons are destroyed to provide the gravity of the universe.
   Neutrino Photons

According to the Ross Model, prior art neutrinos do not exist. My model however replaces the old neutrino with a neutrino photon which I more simply call “neutrino”. According to this model a neutrino is a very high-energy photon (more energetic than gamma ray photons). The reader should note that typical charts showing the electromagnetic spectrum show wavelengths between about 1×10⁸ m and 1×10⁻⁵ m. Note that 1×10⁻¹⁵ m is about the size of a proton. So the two tronnies in a neutrino photon with a wavelength of 1.32×10⁻¹⁵ m (corresponding to photon energy of 939 MeV) as indicated in Table I, would be separated by a distance of only 1.23×10⁻¹⁷ m. The distance across a typical atom is about 10 million times larger and the atom is almost entirely empty space. Even the protons in the atoms are about 100 times larger than the separation of the two tronies in a 939 MeV neutrino photon. This means that photons with energies in the range of 939 MeV and having net charge of zero would pass right through almost everything. The maximum separation between the two tronnies in the neutrino photon (the entron's diameter) is roughly about 76 thousand times smaller than the separation of the tronnies in an X-ray photon. X-rays pass through our bodies. Neutrinos pass through our earth.

Photon Mass, mpₚ=E/3, Photon Energy, Eₚ=½ mV²

The Ross Model proposes a photon mass eequal to one-third of ist totalenergy. This is also the mass of the photon's entron when an entron is traveling in the form of a photon. The path of the entron within the photon defines the width of the photon which is λ/2. The net integrated Coulomb forces in the entron are equal to the rest energy/mass (sometimes referred to as “Eᵣ” or “mᵣ”) of the photon. This rest energy/mass of the photon is equal to one third of the energy of the photon, i.e.:
Eᵣ=mᵣ=Eₜ/3
where Et is the total energy of the photon and Et is:
Eₜ=Eᵣ+Eₖ=Eₜ/3+Eₖ
where Ek is the kinetic energy of the photon, is ½ mv² i.e.:
Eₖ=½(Eᵣ)(v)²=½(mr)(v)²
where v is the velocity of the entron in the photon. The entron travels in a loopy path (which is λ/2 wide) defining the photon path as shown in FIG. 3A. Using FIG. 3A, I have compared the length of a section of the path of the entron to the photon's straight line path and it appears that the distance the entron travels is twice the distance traveled by the photon itself. As described in the above section entitled Photons” the speed of the entron varies from +2.57 c to −0.57 c. Since the velocity of the photon is c (and assuming that the distance traveled by the entron is twice the distance traveled by the photon it inhabits) the average velocity of the entron appears to be 2c. Since the velocity of the entron in a photon is v=2c, we can calculate the kinetic energy of the photon using Eₖ=½ mv²:
Eₖ=(Eₜ/3)(2c)²/2=(Eₜ/3)4c²/2=⅔(Eₜ) c² so,
Eₜ=Eᵣ+Eₖ=Eₜ/3+Eₖ

Thus, with the above analysis, we have proposed a non-zero photon mass equal to one-third the photon's energy. This is reVolutionary idea, surely to be initially refuted by scientist eVerywhere. All prior art models assume that photons have zero mass. (Otherwise, how could they travel at the speed of light?) The prior art also assumes that all (100 percent) of the photon's energy can be converted to mass.

Mass of a Green Light Photon

Based on the above model, we can calculate the mass of any photon with m=(hc/λ)/3. Let's try it for a green light photon with a wavelength λ of 5.3×10⁻⁷ m. The total energy of a photon is equal to:
Et=hc/λ, or Et=hf,
where h is Planck's constant, 80 is the photon wavelength, f is the photon frequency and c is the speed of light. For example, the total energy of a green light photon with λ=5.4×10⁻⁷ m is: Et=hc/λ=(6.626×10⁻³⁴ Js)(3×10⁸ m/s)/5.4×10⁻⁷ m=3.68×10⁻¹⁹ J. One third of this energy is the rest energy/mass Er of the photon's entron. So the rest energy/mass of the green light photon is one-third of 3.6×10⁻¹⁹ J, i.e.:
Er=Et/3=(3.68×10⁻¹⁹ J)/3=1.2×10⁻¹⁹ J=1.2×10⁻¹⁹ kg m²/s².

Converting this result in energy units to mass units using E=mc² we obtain:
m=Er/c²=1.2×10⁻¹⁹ kg m²/s² /(3×10⁸ m/s)²=1.333×10⁻³⁶ kg,

The kinetic energy of the entron (with v=2c) in a green light photon is:
Ek=mv²/2=m(2c)²/2
Ek=(1.333×10⁻³⁶ kg)(6×10⁸ m/s)²/2
Ek=2.48×10⁻¹⁹ kg-m²/s²=2.4×10⁻¹⁹ J

And the total energy of the green light photon is:
Et=Er+Ek=1.2×10⁻¹⁹ J+2.4×10⁻¹⁹ J=3.6×10⁻¹⁹ J,
which is what we started with.

Our conclusion then is that the green light photon has a mass of 1.333×10⁻³⁶ kg (equivalent to 1.2×10⁻¹⁹ J and a kinetic energy of 2.4×10^{31 19} J.

Pair Production: Three Gamma Ray Photons=One Positron and One Electron

As described in the background section, pair production is where a positron and an electron, each with rest mass/energy of 0.51 MeV (9.1×10⁻³¹ kg) each are produced from the interaction of a gamma ray photon (with energy of at least 1.02 MeV. The prior art teaches that the energy of one gamma ray photon is converted into mass during this process. This preferred embodiment of the Ross Model requires the entrons of three gamma ray photons to produce one positron and one electron. The positron is comprised of a minus tronnie and two plus tronnies and the electron is comprised of a plus tronnie and two minus tronnies (a total of six tronnies, 3 plus and 3 minus). The three entrons (each comprised of one plus tronnie and one minus tronnie) also have six tronnies (three plus and three minus).

The total energy of the lowest energy photon that can produce an electron and a positron in pair production is 1.02 MeV which is equivalent to 1.634×10⁻¹³ J=1.634×10⁻¹³ kg-m²/s². If all of the energy can be converted to mass as assumed in the prior art and if E=mc², then the mass m equivalent of this photon should be:
m=1.634×10⁻¹³ kg-m²/s²/(3×10⁸ m/s)²=18.2×10×⁻³¹ kg.

The combined masses of the positron and the electron are also 18.2×10⁻³¹ kg. If the entron of this 1.02 MeV photon could combine with two very low energy (close to zero energy) entrons, the charges and the masses would be conserved. (In parent applications, this is how I explained pair production.) This, however, does not seem very logical since a very low energy entron would have a diameter many orders of magnitude larger than the diameter of the 1.02 MeV entron which is about 1.15×10⁻¹⁴ m which is only slightly larger than the diameter of a proton (about 10⁻¹⁵ m). So, I thought maybe pair production results from the combination of three photons, all having substantially the same energy and size. This makes a much better package. But then we have too much mass—three times too much if the mass represented by the energy of the photon is all of the energy of the photon. However, it works out perfectly if the mass of a photon is one-third of its total energy. In that case mass fits and charges fit. One third of 18.2×10⁻³¹ kg times three equals 18.2×10⁻³¹ kg. Amazing!

There are many huge consequences of my “discovery” (I could also use the terms, “assumption” or “speculation”) that photons might have a mass of Et/3. A very important result of this discovery is that the photon's kinetic energy can be ½ mv² (where v is the velocity of the entron and equal to 2c) as well as mc², so we have old physics (Ek=½ mv²) now happily agreeing with modern physics (E=mc^{2,} where c is the photon's velocity). Another very important consequence is that pair production now requires three high energy gamma ray photons to be at the same place at the same time. See FIG. 3C extracted from Modern Physics by Pfeffer and Nir. This chart shows attenuation coefficients for high-energy gamma ray photons. Note that Compton scattering and the photoelectric effect decrease with increasing photon energy; whereas pair production attenuation starts at 1.02 MeV and increases with photon energy up to 10 MeV. The chart does not indicate what happens at photon energies greater than 10 MeV. This chart and many others like it have lead people to believe that although attenuation by Compton scattering and the photoelectric effect have dropped to close to zero at 10 MeV, pair production continues to increase beyond 10 MeV without limit. What the prior art does not know is that the attenuation of very high energy photons (energies substantially greater than 10 MeV) is substantially zero. There two reasons for this: (1) the higher the energy the smaller the photon and (2) we have to have the entrons of three high-energy gamma ray photons in the same place and at the same time to have pair production. This means that very high-energy gamma rays are not attenuated in matter but pass right through it. As explained above, I have named these very high energy gamma ray photons, “neutrino photons” or “neutrinos”. I hope people will forgive me for usurping the name “neutrino” for these very high-energy gamma ray photons. I did it for two reasons. First, I understand neutrino means “little neutral one” in Italian. (Enrico Fermi picked the name for the prior-art neutrino.) Second, the prior-art neutrino does not exist according to the Ross Model; therefore it does not need a name.

The Ross Model predicts neutrino photons with energies in the range of 939 MeV as the carriers of gravity and the source of most of the mass of protons and the universe. These photons are probably be impossible to detect. Preferred embodiments of the present invention model pair production as peaking somewhere after 10 MeV (probably between 10 MeV and 100 MeV and then dropping to almost zero at energies much lower than 939 MeV. For a 939 MeV photon the photon width would be 6.6×10⁻¹⁶ m and the entron diameter would be in the range of about 1.23×10⁻¹⁷ m. At these dimensions the probability of three of them being in the same place at the same time is extremely small unless the flux is extremely high. Therefore, nearly all neutrino photons illuminating the earth pass through the earth just X-ray photons pass through the fatty tissue of your body. I am suggesting that single gamma ray photons are not attenuated by pair production. Basically, isolated gammas pass harmlessly through them scientists and their instruments so they are not detected. According to my model, pair production also falls off at higher photon energies even in high flux situations because as the energy increases the “size” (i.e. diameter) of the entrons grows proportionately smaller so having three in the same place at the same time becomes less and less probable with increasing energy. I have read that scientists operating large underground neutrino detectors detect what they think are neutrinos from nearby nuclear reactors. My guess is these are nothing more than three high-energy gammas that traveled all the way from the reactor to the detector and finally combined in the detector to produce a positron-electron pair.

Photons are Entrons Floating in Coulombic Fields Flowing at the Speed of Light

Entrons float in Coulombic fields. A beam of light is typically a very, very large number of photons traveling at the “speed of light”. The tronnies in the entrons in the photons in the beam of light produce a light speed Coulombic river of plus and minus charges and a Coulombic grid flowing wave-like at the speed of light. The circling tronnies of the entrons both create and float in this Coulombic river. The photons travel at the speed of light. The entrons make one loop for each wavelength of the photon within the photon path which has a width that is one half the photon wavelength with the entron traveling twice the distance and at an average speed of twice the speed of the photon, i.e. twice the “speed of light”.

Are Photons a Particles or Waves?

The prior art does not know whether light is a wave or a particle. The Ross Model says a photon is both a wave and a particle. The entron portion of the photon is a particle in the same sense that an electron is a particle. (An entron is comprised of two tronnies and an electron [a naked electron] is comprised of three tronnies.) The entron carries the mass of the photon. The entron can exist in many forms other than as a component of a photon. It can be captured by an electron or a proton to become part of the electron or the proton. It can be trapped in matter in the form of a heat quantum, later to be released as part of another photon. But the entron and all the other entrons in a beam of light with their charges produce Coulomb force waves that travel out from their positions spherically to produce a Coulomb wave structure that the entrons in the beam ride in. The entron of a single photon can create a wave on which it can travel at the speed of light through a laboratory or through the universe. The photon is the combination of the entron particle and the Coulombic wave the entron produces in which the entron rides. So the photon is a particle and a wave!

Reflection and Refraction

The looping path of the entron has the speed of the entron dropping to zero once each wavelength of the photon it is a part of and traveling backwards through a significant portion of each wavelength. At surfaces such as the surface of a lake, a mirror, a window or a tree leaf, Coulombic fields flow out from the surface at the speed of light perpendicular to the surface especially at small angles with the surface. Therefore it is easy for an entron to change directions at surfaces. Entrons floating in a beam of light intersecting these surfaces at an incident angle float in the Coulombic field flowing out from the surface as well as the field of its incoming beam so they often reflect from the surface at a reflection angle equal to the incident angle. Entrons illuminating a material of higher index of refraction that are not relected or absorbed at the surface of a material flow with its wave into the material at a slower speed bending toward the normal to the surface in a wave-like pattern.

A “Single Photon—Two Slit” Explanation

One of the fundamental mysteries of physics is the single photon -two slit experiment. In this single photons (coming one at a time) illuminating two slits in a first screen produce a diffraction pattern on a second screen. This mystery is described in many physics books. For example, Fundamentals of Physics, Halliday, Resnick and Walker, Sixth Ed., John Wiley &Sons, Inc. at pages 962-964. The question is how could single photons produce diffraction patterns. How could a photon passing through one of the two slits even be aware that there is a second slit? The best explanation the prior art can give is that the light is produced as a photon and is absorbed as a photon but “travels between the source and the detector as a probability wave”. The Ross Model provides a much simpler solution. The entron portion of each photon passes through only one of the two slits but its Coulombic wave passes through both slits and both parts of its wave combine to direct the path of the entron portion of the photon on the opposite side of the first screen.

Polarization

The two tronnies of each entron spin in a plane. If the entron is the energy portion of a photon, the photon spins in the plane of the entron spin which also includes the photon direction. In most light beams the spin direction of the entron and its photon is random about the photon direction (the photon axis). Light beams become partially polarized upon reflection from smooth surfaces. This is because the entrons want to circle parallel to both the direction of the beam and the direction perpendicular to the surface. This is natural for the plane that includes the directions of incoming beam and the reflected beam, so this is one of the polarizations. This plane includes the normal to the surface. The other reflected polarization is perpendicular to that direction. I recognize that this explanation of polarization appears a little flakey. I have tried many explanations of polarization but none seem really simple. I have also tried to understand polarization under other theories of light. None really make much sense to me. Light can be polarized by a number of techniques other than reflection and the polarization of a light beam can be changed with wave plates and it can be rotated with magnetic fields. I believe my model can explain polarization but it is probably going to take someone much more expert in optics than I who is a believer in tronnies and entrons to provide that explanation.

Photon Absorption

When photons react with matter, they may be reflected or transmitted without loss of energy. They may also be absorbed to create an excited atom or molecule. And they may be absorbed in the matter as heat energy. High-energy x-rays and gamma rays are attenuated via the photo-electric effect, Compton scattering or pair production. It is the entron that is the energy/mass of the photon. When the photon is trapped in matter for a short time or for a very long time, it ceases to exist as a photon but its entron does not cease to exist. It can however transfer part of its energy to other entrons or the tronnies of entrons can change partners with the tronnies of other entrons. For example, more than one entron can be captured by the same electron. When this happens as indicated in FIGS. 2E(1), 2E(2) and 2E(3), the tronnies of the one of entrons is brought closer to the tronnies of a separate entron than it is to its partner. The result can be a higher energy enteon and a lower energy entron. In a microwave oven entrons of a single frequency become absorbed in what is cooking and the result is a hot product with a wide range of entron energies. These are radiated away or conducted away as the product cools. As discussed above, three high-energy entrons can produce an electron and positron pair. Most entrons trapped in matter radiate from the matter in the form of photons In a reaction described as the photoelectric effect, the entron portion of the photon is absorbed by an electron giving the electron all of the entron energy. In Compton scattering the entron is absorbed by an electron, but an entron previously a part of the electron is ejected and we monitor the ejected entron as a photon.

Neutrinos and Gravity

Neutrinos in the prior art are things that travel at the speed of light and are able to pass through the earth. Prior art neutrinos are thought to have energies in the range of about 1.0 MeV or less and are thought to be associated with beta decay. In the Ross Model neutrinos are not the neutrinos of prior art theories. In fact according to these preferred models the prior art neutrino does not exist. My neutrinos are all high-energy photons (much higher than 10 MeV), each comprised of one entron that in turn is comprised of two circling tronnies, one plus and one minus. All neutrinos have energies substantially greater than gamma rays. (Prior art neutrinos have the same spin as an electron, travel at or approximately at the speed of light and may or may not have mass. The prior art does not know whether the prior art neutrino has mass. My neutrinos are photons, with lots of energy, with the same spin as the prior art photon and travel, like the photon, at the speed of light.) My neutrinos, like other photons, travel in substantially straight lines at the speed of light with its entron traveling a loopy path within the photon path that has a width of λ/2 where λ is the neutrino's wavelength. My neutrino photons, like all other photons, have the same “spin” as other photons. They do not have the same spin as electrons and protons. The diameter of the entron in a 936 MeV neutrino photon is in the range of about 1.23×10⁻¹⁷ m. It is so small that the neutrino photon very rarely reacts with anything. Most neutrinos illuminating the earth pass right through it. Neutrinos can pass right through the nuclei of atoms (10⁻¹⁴ m) or even a proton (10⁻¹⁵ m). Gravity results from the Coulomb force fields emanating from neutrinos as the neutrinos pass at the speed of light through matter. These Coulomb force fields travel rearward and sideways along the trail of the neutrinos. The sideways components cancel, but the rearward components add pushing the matter through which they are passing back toward the source of the neutrinos. Thus, neutrinos from the sun passing through the earth provide the “gravity” holding the earth in its orbit around the sun. (Some estimates put the neutrino flux from the sun is 100,000,000 per square centimeter per second, but these estimates refer to prior art neutrinos so I am unsure if these numbers apply to my neutrino photons. The flux must be large, however, or otherwise small things would not feel the force of gravity.) Neutrinos from the black hole in the center of the Milky Way hold all the stars of the Milky Way (including our sun) and us in our positions in our galaxy. Neutrinos captured in the earth and later released provide the earth its gravity. Neutrino entrons can be captured by electrons. I do not know the size of electrons but I believe that high-energy electrons can be smaller than about 10⁻¹⁸ m. Entrons (with diameters of about 1.23×10⁻¹⁷ m) captured by electrons are responsible for most of the energy/mass of high-energy electrons. If it is captured by and electron or positron, the entron increases the energy/mass of the electron or positron by 313 MeV (5.5×10⁻²⁸ kg in mass units). Two high-energy positrons and one high-energy electron make up a proton with an energy mass of about 939 MeV about 1800 times the mass of an electron. Protons are destroyed in black holes releasing their neutrino entrons that stream out from the black hole as neutrino photons providing the gravity that holds galaxies together. Some of these neutrinos are captured and released or scattered randomly by stars, planets (including our earth) and moons and other massive things in the galaxy providing gravity for those things. Neutrinos (my type of neutrinos) may also be released by nuclear reactions in our sun and other stars and other massive bodies, but it may also be that neutrinos can only be produced by the destruction of protons. This may limit their productions to black holes. In this case, the sun's gravity would result from neutrinos captured our Milky Way black hole and then released randomly. The reader should keep in mind my definition of a neutrino. It is a photon with energy high enough that it has a high probability of passing through the earth. High-energy photons that do not have a high probability of passing through the earth are gamma rays.

### Electrons

Produced in Pair Production

As described in detail above, three entrons (together comprised of a total of three plus tronnies and three minus tronnies), each of the entrons being an entron of a high-energy (gamma ray) photon and having an energy greater than 1.02 MeV combine in “pair production” to produce a pair of electrons (a negatron and a positron). As explained above two thirds of the photon energy is kinetic energy and one third of its energy represents the mass of the photon. The negatron is comprised of a plus tronnie orbiting in a tight circle of radius r at a speed of 1.57 times the speed of light with two minus tronies orbiting around the circular path of the plus tronnie, also at radius r, one-fourth period behind the plus tronnie. The positron is comprised of a minus tronnie and two plus tronnies with their positions reversed from that of the negatron. (Although tronnies have no mass and as such provide no resistance to any applied force, when a tronnie combines with another tronnie to form an entron or two other tronnies to form an electron, the resulting dynamic combination does provide a resistance to applied forces. This is mass or its equivalent, energy.)

Positrons and Negatrons

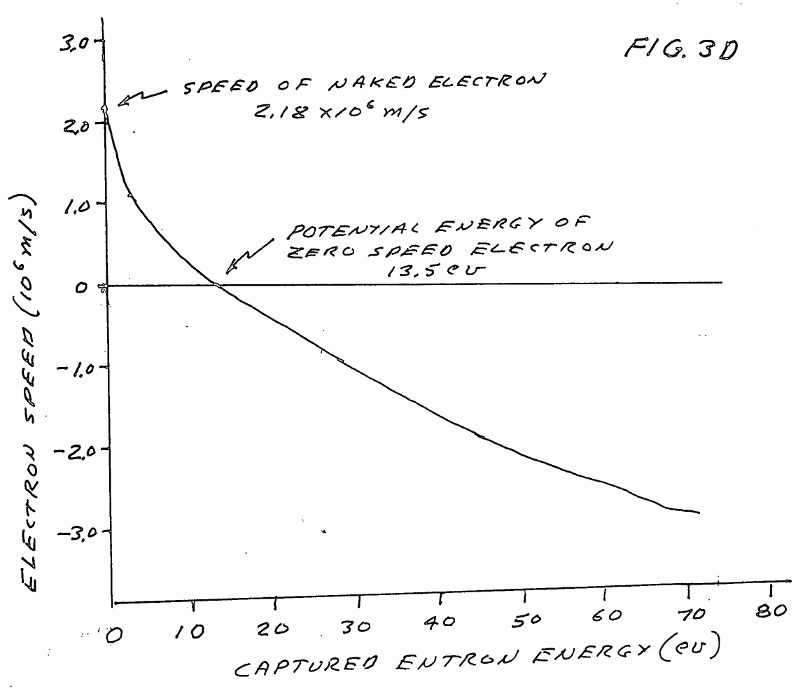

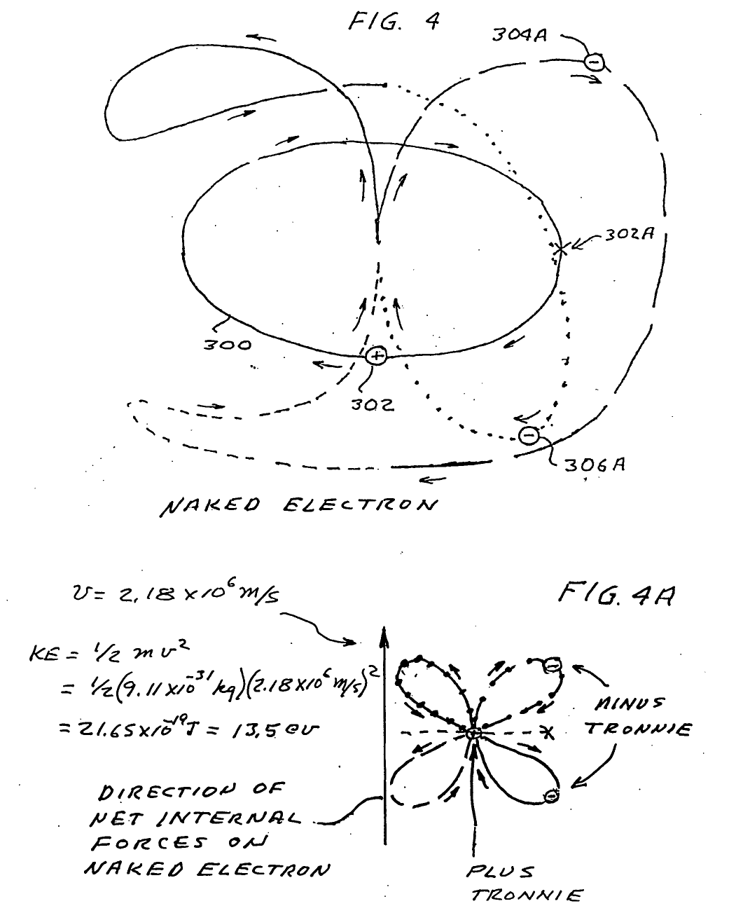

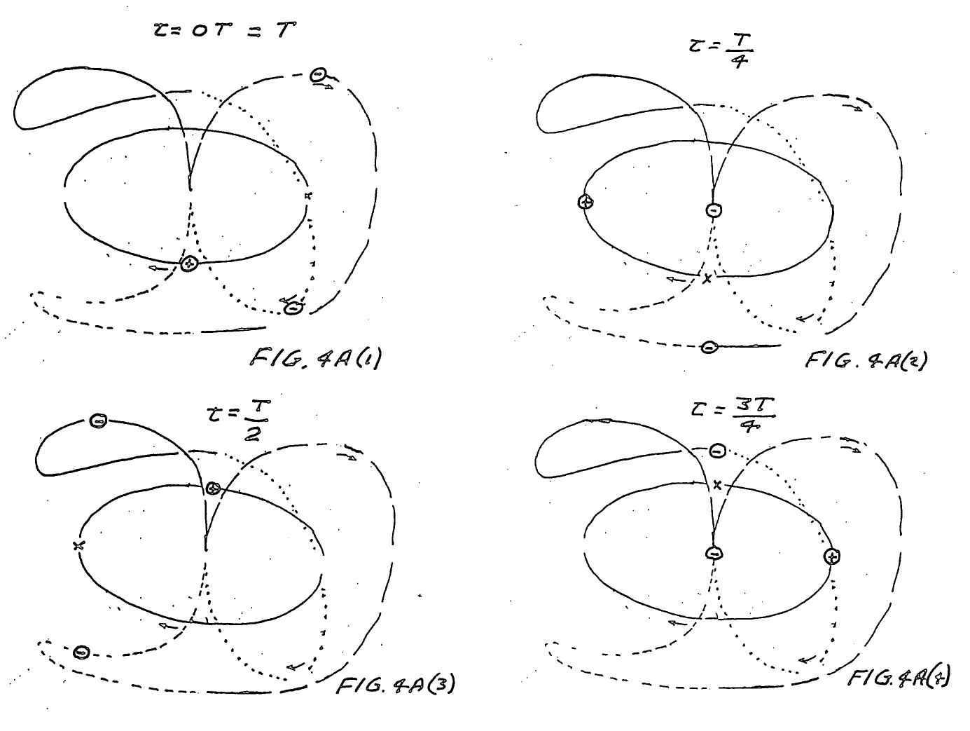

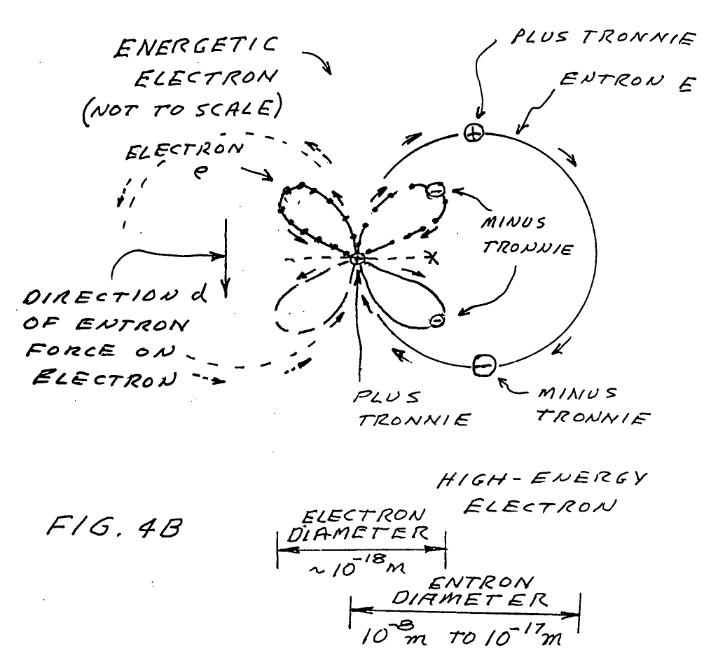

My latest electron model is shown in FIG. 4. This is a negative electron, a negatron. A plus tronnie 302 follows a circular path and two minus tronnies 304A and 306A orbit the path one-fourth period behind the circling plus tronnie. The negatron in this figure is viewed from a position 30 degrees above the plane of the plus tronnie's circular path 300. The path of minus tronnie 304A is shown in long dashes above the plus tronnie's plane and short dashes below the plane. The path of the minus tronnie 306A is shown in solid line above the plane and dots below the plane. FIG. 4 represents a snap shot drawing at a time, t=0. Three arrows show the direction of the three tronnies at the time of the snap shot. The positron is exactly the same as a negatron except the sign of the three tronnies are reversed. In the negatron the central circling tronnie is a minus tronnie and the two tronnies orbiting the circular path are plus tronnies.

There are an Equal Number of Positrons and Negatrons in the Universe

The positron and the negatron are produced in a pair production process as explained above as the result of the marriage of three high-energy entrons. I suspect that it is impossible for to form a positron without, at the same time, forming a negatron, and vice versa. I am not certain of the dimensions of the electrons. The dimensions must be non-zero since tronnies 304 and 306 must pass through the center of the path of tronnie 302. (The electron is definitely not a point particle.) I have not worked out the details of the process of pair production. The process must occur in a volume about the size of or smaller than about 10⁻¹⁴ m. As indicated in Table I, the diameter of the entron in the lowest energy gamma ray photons that can create electron pairs is 1.15×10⁻¹⁴ m. This is a little larger than a proton. At the beginning of the process, we must have the six tronnies circling within this volume. The electron must be much smaller since a proton is comprised of three of them. I think the size of an electron is about 10⁻¹⁸ meters. I doubt if the size of the electron and positron are dependent on the energy of the gamma ray that formed it. If all electrons (at rest energy) are the same (which is my understanding), there must be an equilibrium electron structure. I believe the six tronnies of the three entrons form into a dynamic spiraling structure with initial dimensions of about 10⁻¹⁴ to 10⁻¹⁵ meters that collapses to a circling configuration within a volume with dimensions in the range of about 10⁻¹⁸ meters and then splits into two parts, a positron and a negatron. I also believe that it is impossible to destroy an electron or a positron except by the two annihilating each other. Therefore, if this is the case, there should be exactly the same number of positrons in the universe as negatrons. This is an important prediction of the Ross Model. Once formed each of the two electrons (the positron and the negatron) probable collapses into a very tight small and stable dynamic structure that I call the “tripple tronnie twirl”. The Coulomb forces holding the electron together are tremendous (a diameter of 10⁻¹⁸ meters would imply force of about 2.3×10⁸ Newtons, two hundred million Newtons) and the tronnie speeds are in excess of the speed of light (substantially more than 300 million meters per second). What wonderful things these electrons are!

Electrons Provide their Own Propulsion

Internal forces in naked electrons drive them at a velocity that is a significant fraction of the speed of light. In preferred models the natural velocity of an electron (or positron) is 2.18×10⁶ m/s. (This speed is a little less than one percent of the speed of light. A speed of 2.18×10⁶ M/s is faster than 4.8 million miles per hour!) The preferred model of the electron shown in FIG. 4 shows the plus tronnie circling and the two minus circling the circular path of the plus tronnie one-forth period behind the plus tronnie. Both minus tronnies pass upward through the circle of the plus tronnie once each period and assuming the diameter of the electron is about 10⁻¹⁸ m, the electron's frequency is about 1.5×10²⁶ cycles per second. On each pass through the plus tronnies circle the minus tronnies pull the plus tronnie a distance equal to a little less than one percent of the diameter of the pluys tronnie's circle. The direction of the path is perpendicular to the plane of the plus tronnie's circle and the in the direction of the minus tronnies as they pass through the center of the circle.

Electron with Captured Entrons

The electron I described in the preceding section is an electron in its zero energy state, which means it carries no excess energy. However, it does have kinetic energy (since it has mass and velocity, E=mv²/2) of 21.6×10⁻¹⁹ J or 13.5 eV. A plus or minus electron can capture the entron portion of a photon to become an excited state electron. An entron with energies lower than 13.5 actually slows down the electron. An 13.5 eV entron will reduce the electron's speed to substantially zero. Entrons with energies greater than 13.5 eV will drive the electron in the direction opposite its natural direction. Above 13.5 eV the electron speed depends on the energy of the entron (the smaller the diameter of the entron, the greater its energy, the greater its frequency, the greater the speed of the electron). See FIG. 3D. However, the electrons speed (in the Coulombic frame in which it is located) is limited to the speed of light. Whether above or below 13.5 eV, these captured entrons provide the electron with its “voltage” (or energy). Electrons (plus and minus) can capture the entron portions of neutrino photons, greatly increasing the electron's mass/energy and increasing the electrons velocity to more than 0.99999 times the speed of light. My current preferred model of a high-energy electron is shown in FIG. 4B and 4B(1). As entron E passes through electron e, the tronnies of entron E exert a repulsive force on electron e driving it in direction d as shown in FIG. 4B. The higher the energy of the entron the greater will be the speed of electron e in direction d which is opposite the natural “naked” direction of electron e. Since the dimensions of electron e are assumed to be in the range of 10⁻¹⁸ m and the dimensions of entrons are typically much larger, FIG. 4B is obviously not to scale for typical high-energy electrons. FIG. 4B(1) shows an energetic electron more to scale where the circle of the entron is much larger than the electron that has captured it.

In preferred embodiments the electron can capture several or many entrons and their energies are additive. See FIGS. 2E(1), 2E(2) and 2E(3). FIG. 2E(1) shows net tangential forces in a typical entron having a single plus and a single minus tronnie. FIG. 2E(2) shows net tangential forces when two entrons combine with two plus and two minus tronnies circling on the same path. FIG. 2E(3) shows net tangential forces when three entrons combine with three plus and three minus tronnies circling on the same path. These combinations can occur when an electron captures more than one entron An electron having captured three entrons with energies of 10 eV each would have 30 eV of excess energy that could be released a photons. Also, in preferred embodiments the tronnies in these entrons trade partners so that an entrons of 20 eV, 10 eV and 0 eV can be created as suggested above. A further combination could produce a 30 eV entron and two entrons of 0 eV. An example of a combination of entrons is a microwave oven where very low energy entrons combine to produce much higher energy entrons that are responsible for cooking our food.

Entrons (as will be explained below) are also manifested as thermal energy, so that electrons (other than naked electrons closely circling atomic nuclei) will always (except at very low temperatures) carry some excess energy. At normal temperatures (e.g. about 293 degrees K. or about 68 degrees F. the entron energies will be less than 1 eV. So conduction electrons at 68 degrees F. of a grounded conductor will have a voltage of less that one volt.

Voltage, Entrons and Photons

The voltage on an electrically hot conductor is determined by the energy (in volts) of entrons captured by all of the conduction electrons in the conductor. For example, in a conductor connected to the hot terminal of a grounded 12-volt battery, all of the conduction electrons have captured a 12-volt entron with a diameter of about 9.7×10⁻¹⁰ m. This is in addition to the entrons captured by electrons at the ground terminal of the battery. One of these entrons as the energy part of a photon would form ultraviolet light with a wavelength of 1.03×10⁻⁷ m. A 3-volt battery would provide entrons with a diameter of 3.8×10⁻⁹ m and these entrons in photon form would be visible blue light with wavelengths of 4.1×10⁻⁷ m. When electrons flow through a resister they tend to lose their entrons in the resister. These lost entrons are the heat energy produced by the electric current flowing through the resister. When batteries are connected in series, entrons representing the battery voltage add to the energy of the electrons at the low voltage terminal of each battery, so three 12-volt batteries in series will produce electrons with entron energies of about 36 eV.

Electric Current

All electrons in atoms that are in their ground states circling the nuclei of an atom, are electrons with no captured entrons and in the Ross Model they are called naked electrons as explained in the above section. They are circling the nucleus at a velocity of about 2.18×10⁶ M/S. Conduction electrons typically have captures at least one entron and would be traveling at a velocity different from 2.18×10⁶ m/s (usually much slower). Entrons captured by atomic electrons (in addition to normally slowing them down) also put them in excited states. They drop from their excited states to a lower excited state or ground state by releasing the entrons (often as photons) and (if at the ground state) speed back up to 2.18×10⁶ m/s. The entrons trapped by conduction electrons define the electron's energy or voltage. The tronnies of low-energy entrons (less energetic than 13.5 eV) loop through electrons and the Coulomb forces from the looping tronnies provide a backward force on the electrons to slow down the electrons to reduce the electron velocity and kinetic energy. A 13.5 eV entron reduces the electron velocity to about zero. Higher energy entrons give the electron a velocity that can be any velocity up to very close to the speed of light in a direction opposite the direction of its naked velocity.

FIG. 5 shows a very simple electric circuit with 24-volt battery 142 and 24-volt lamp 146 separated by a one-mile copper pair with switch 156 near the battery. When the switch 156 is closed the light begins to glow almost instantly long before electrons could possibly travel the one-mile length of the copper pair. The popular explanation is that electrons near the battery push on other electrons so that an electron-domino effect pushes electrons that had been near the lamp through the lamp filament. The result is that the effective speed of the current in the circuit is a large fraction of the speed of light.

I do not have it yet, but I believe my model will provide the explanation for the speed of electricity through copper wires. The tronnies could certainly travel from one end of the wire to the other at net speeds near the speed of light. (Their instantaneous speed must always be as great as or greater than the speed of light.) But I don't believe the individual tronnies carry the electric energy through the copper wire. I believe that it is the entrons that make the trip from one end of the wire to the other. All of the entrons captured by electrons at the low-voltage terminal of the battery have the same energy and all of the entrons captured by electrons at the high-voltage terminal of the battery have the same energy, and that energy at the high voltage terminal is 12 eV higher than the energy of the entrons captured by electrons at the low voltage terminal.

As indicated by Table I, entrons with energies in the range of a few volts have dimensions about the size of atoms and as indicated by FIG. 3D, electron speeds are a fraction of the speed of light. Therefore, the association between an electron and the entron it has captured is probably a very loose one. So entrons can jump off a high-voltage electrons coming out of the battery and travel through a conductor very quickly until all of the conduction electrons in the conductor have captured entrons of the same energy. At this point the entire conductor between the battery and the lamp is charged to 12 volts. As the capturing electrons near the lamp attempt to pass through the filament of the lamp the entrons escape from the capturing electrons and become quanta of heat in the filament. As explained below entrons captured in matter are the heat quanta in the matter and define the temperature. The more captured entrons the greater the heat and the higher the temperature. Entrons captured in matter can share energy with each other to produce an energy distribution. Some of these entrons will escape the filament in the form of photons. If the temperature is high enough some of these photons will be visible light photons

Magnetic Fields

Magnetic fields are the tronnies of entrons traveling in large loops, such as through a bar magnetic, out the north end and in the south end or through the earth, out the north pole and in the south pole of the earth. They travel like the cars of a freight train (with alternating plus and minus tronnies) through circling currents produced by looping electric currents such as electrons flowing in a coil or the electrons circling in aligned iron atoms.

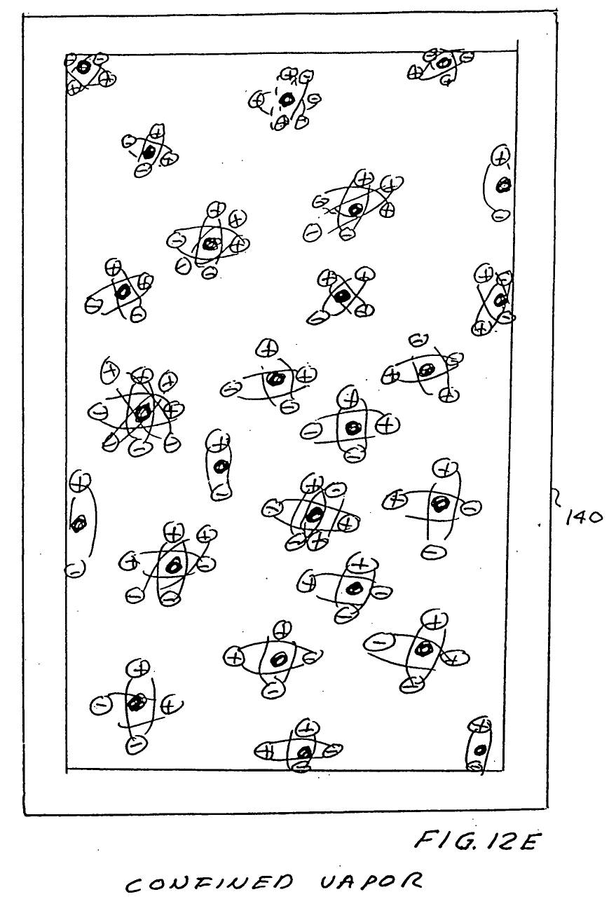

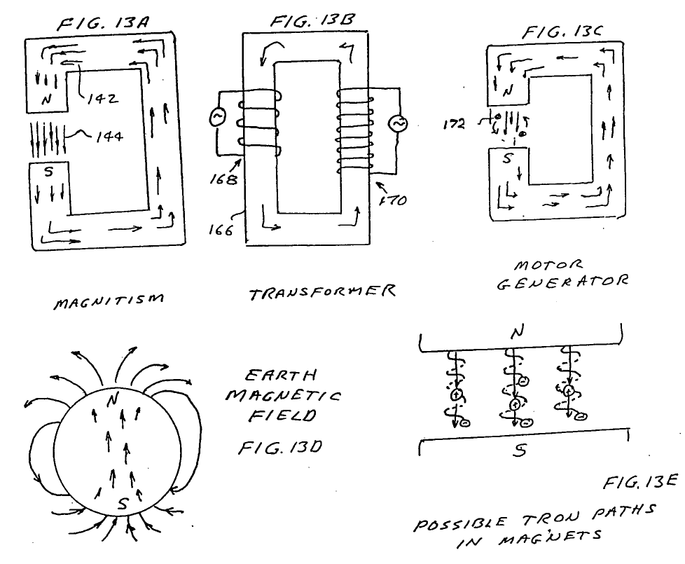

All solids above absolute temperature have a lot of captured tronnies. These tronnies normally come in as entrons through conduction or radiation and tend to remain as entrons within the solid. What is important is that it be free to travel at the speed of light or greater. If a tronnie slows down it faces an infinite Coulomb force from immediately behind itself. The tronnie typically likes to be paired up because that allows the to go at a speed greater than the speed of light in a circle with its partner pulling him through his own force field at points half-way around the circle as shown at 86A in FIG. 2. However, if conditions are right the tronnie is just as happy making longer loops so long as the tronnie can do it at the speed of light or greater. This is what I believe happens in a permanent magnetic as shown in FIG. 13A. Here tronnies 142 loop around the magnet moving at the speed of light. They can continue across gaps as shown at 144 in this horse shoe magnetic. If this were a bar magnetic the tronnies would exit the bar at one pole, loop around on the outside and enter at the other pole. Magnets can be created with materials such as iron and a current carrying coil as is well known.

I have not figured out which tronnie takes the route shown by arrows 142 and 144 in FIG. 13A. I think it is the positive tronnies in most magnets and the negative tronnies orbit around the positive tronnies in a helical pattern as shown in FIG. 13E. FIG. 13B shows a transformer. Here electrons flow in four loops 168 around iron core 166. The fields set up by the orbiting electrons and minus tronnies pushed along by the electrons allow plus tronnies to flow freely around iron core 166 at speeds equal to or greater than the speed of light. If the current in primary winding 168 is alternating then the direction of the tronnie flow will alternate accordingly. This will produce an alternating flow of negative tronnies around core 166 that will create a current in loop 170.

FIG. 13D depicts the earth's magnetic field. I believe that circulating metals in the earth's interior create conditions under which tronnies are able to travel through and around the earth as shown in the figure. Since their speeds are in the range of the speed of light or greater, the round trip is probably less than a second. FIG. 13C represents motors and generators, which involves conductors rotating in magnetic fields. I have not figured out exactly how electricity is generated and exactly how the flowing tronnies and electrons turn the motor shaft. I think it works like this: As a conductor 172 passes through the magnetic field (i.e., the streaming tronnies) shown at 172 in FIG. 13C plus tronnies in the conductor are forced in one direction and minus tronnies are forced in the opposite direction. When the conductor loops around and passes back through the streaming tronnies in the opposite direction then the tronnies in the conductor are forced in directions opposite those of the first pass. Another possibility is that the tronnies shown in FIG. 13E are captured into the conductor as it makes one pass through the streaming tronnies and exits the conductor into the stream when the conductor passes back through the stream in the opposite direction.

### Protons, Neutrons and Atomic Nuclei

The Proton

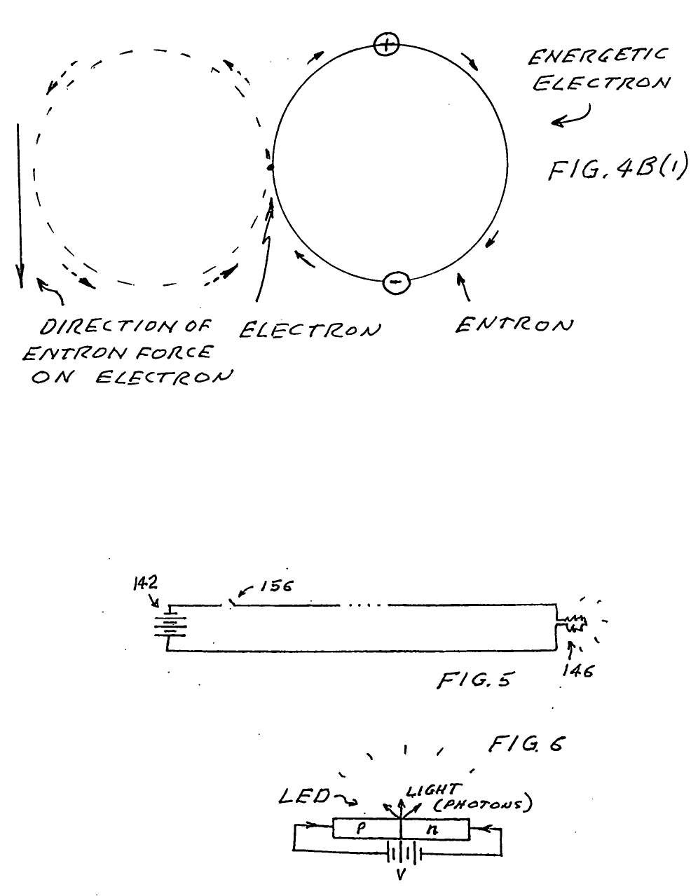

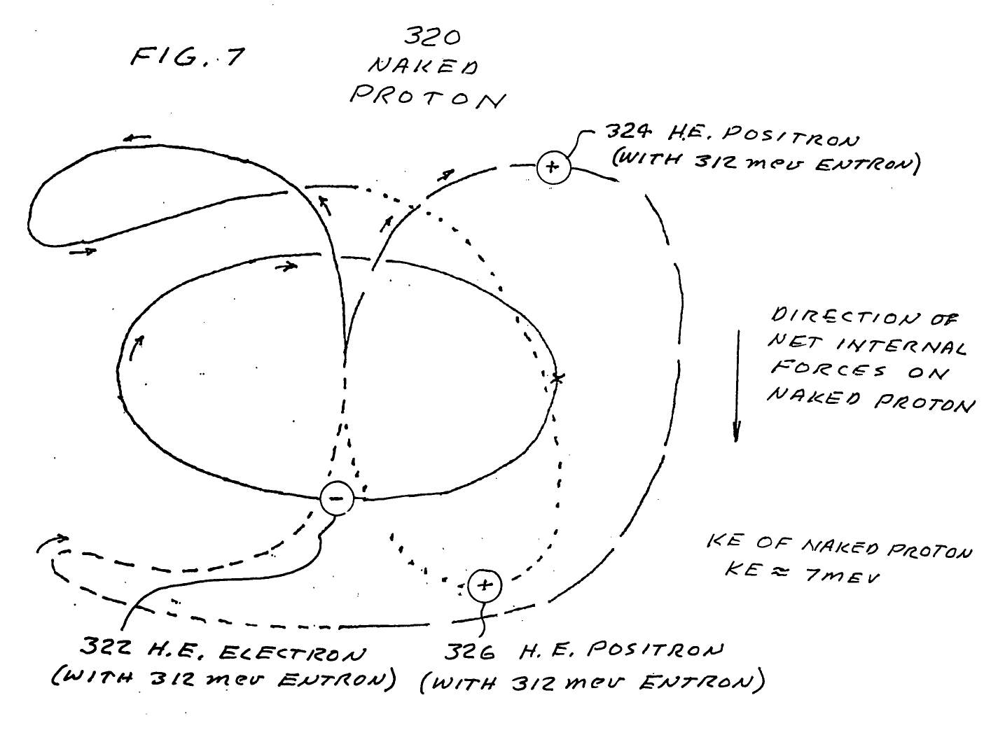

A model of a naked proton is shown in FIG. 7. Three very high-energy electrons (one negatron and two positrons, each having captured the entron part of a 939 neutrino photon (each with a mass of 5.5×10⁻²⁸ kg see Table I) to increase the mass of each electron about 600 hundred times) combine to form each proton (with mass about 1800 times the rest mass of an electron [about 0.511 MeV (9.1×10⁻³¹ kg) for the electron and about 931MeV (1.67×10⁻²⁷ kg) for the proton]). The speed of these high-energy electrons is close to the speed of light (about 0.999998616 c). The measured proton mass/energy as reported in the Background Section is 938.272338 MeV. I use 931.06768 MeV for the mass of the naked proton. I derived this number by subtracting the mass of two electrons from the mass of the helium 4 isotope to get an estimate of the mass of the helium nucleus (the alpha particle) and then subtracting the mass of two more electrons which I believe comprise part of the alpha particle. Then I divide the result by four to obtain my estimate of the proton mass inside the alpha particle. The result is 931.06768 MeV for the mass of the naked proton. My assumption is that the four protons lose the mass difference (i.e. 7.204658 MeV in the course of fusions reactions to produce helium. I call the low mass proton, a “naked” proton because I believe that the mass difference is accounted for by one or more entrons that the naked proton has captured in order to slow down to enough from near the speed of light to be a good neighbor in an approximately stationary reference frame. In my preferred model, the naked proton drives itself with its internal Coulomb forces at a velocity of about 12 percent of the speed of light (about 0.36 X 10⁸ m/s). This is how fast a proton with mass of about 931 MeV would have to travel to increase its mass to little more than 938 MeV using the relativity formula. (Using old E=mv²/2 formula to relate velocity to kinetic energy, a 931 MeV proton (1.660×10⁻³³ kg) at a speed of 0.36×10⁸ M/s is about 0.1076×10⁻¹⁷ Joules which is equivalent to 6.72 MeV.) I am guessing that in order to slow down to approximately zero speed, the proton needs to capture entrons with energy approximately equivalent to its kinetic energy. So, according to this model, the many trillion protons in hydrogen atoms in our bodies are each lugging around about 7 MeV of entron energy to slow them down enough so they can be a part of us. This amount of energy is the energy per proton released in our sun when it combines these nuclei of hydrogen to make helium nuclei.

This proton model as shown in FIG. 7 is very similar to the positron version of my electron model shown in FIG. 4 except in the place of the minus and the two plus tronnies we have a negatron 322 in the circular loop and the two positrons 324 and 326 orbiting the circular loop. These electrons are being driven in their paths by trapped high-energy entrons (i.e., the entrons of 939 MeV neutrino photons). The frequency of the high-energy entrons is high enough so that the energy/mass of the proton is increased by a factor of about 1800 compared to the energy/mass of an electron. For example, the neutrino photon listed in Table I has energy equal to 939 MeV (with its entron having a mass equivalent to 5.5×10⁻²⁸ kg). The masses of three of these entrons plus the 0.511 MeV rest masses of the negatron and two positrons gives the mass energy of the proton at about 939.2 MeV (1.67×10⁻²⁷ kg). The reader should note that the size of the neutrinos entrons is about 1.23×10⁻¹⁷ m compared to a proton size of about 1×10⁻¹⁵ m. I recognize that this model of the proton seems somewhat complicated, with one negatron, two positrons and three neutrino entrons driving the negatron and the two positrons in their orbits. However, my understanding is that the ultimate products of a proton—anti-proton annihilation are positrons, negatrons and neutrinos. Each of the three electrons and their associated neutrino entrons have features similar the things some people are calling quarks. (No one has ever seen a quark.) The high-energy electron 322 comprised of (1) a naked electron (with one plus tronnie and two minus tronnies) plus (2) its driving entron (with one plus tronnie and one minus tronnie) may be mistaken for a down quark with negative charge of minus ⅓ e. Also, the two high-energy positrons 324 and 326, each comprised of (1) a naked positron (with one minus tronnie and two plus tronnies) plus (2) its driving entron (with one plus tronnie and one minus tronnie) may be mistaken for up quarks, each with a positive charge of plus ⅔ e. (The quark model of the proton provides a net charge of plus one for the proton as does the Ross Model.) I suspect that the movements of all of these tronnies (in this model there are 15 of them: 7 minus and 8 plus) are precisely synchronized with each other with enormous Coulomb forces holding them dynamically in place. I am looking forward to some smart computer person creating a 3-D computer model corresponding to this model so we can watch all the little tronnies looping around each other.

The anti-proton is just the opposite of the proton and comprises a positron in the place of negatron 322 in FIG. 7 and two negatrons in the place of positrons 324 and 326. Like the electrons, the proton and the anti-proton are held together by enormous Coulomb forces and are extremely stable except through the process of annihilation with each other.

The Neutron

My latest neutron model is shown in FIG. 8. A neutron shown at 321 is a proton with an extra negatron with a captured entron propelling it at about one percent of the speed of light. The proton is shown at 320. The circulating electron e is circling on path 321A and its captured entron shown at 321B is pushing the electron around the proton at a speed of about one percent of the speed of light. This entron has an energy of 0.74 MeV (equivalent to a mass of 0.0023055×10⁻²⁷ kg). This mass is the mass difference between (1) the mass of a neutron and (2) the mass of a proton plus the mass of an electron. The corresponding diameter of the entron is 1.56×10⁻¹⁴ m. In my preferred model of the neutron the two tronnies of the entron like the two positrons pass through the center of the proton part of the neutron. Unlike the proton, I see now way to find three quarks in my neutron model. (The reader should note here, no strong force is needed, just an electron and its captured entron.) So the nucleus of an atom is (according to my preferred model) nothing more than a combination of protons and negatrons (along with a variety of entrons) all in dynamic equilibrium. Some specific configurations are proposed. There is no “strong” force holding the nuclei together. Coulomb forces hold them together. The Coulomb force is the only force in the universe.

The Deuteron

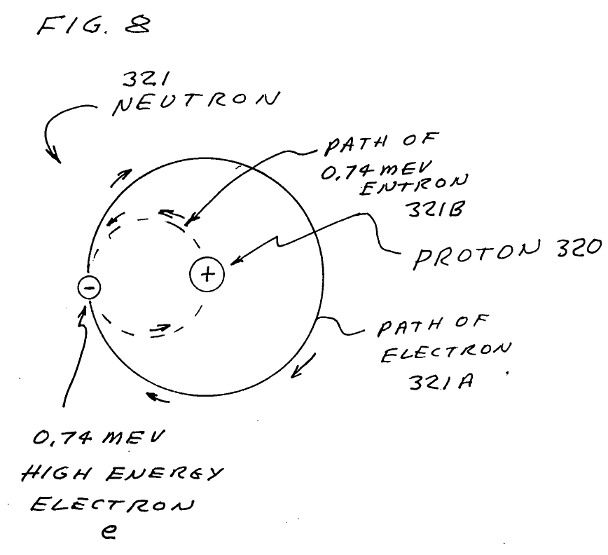

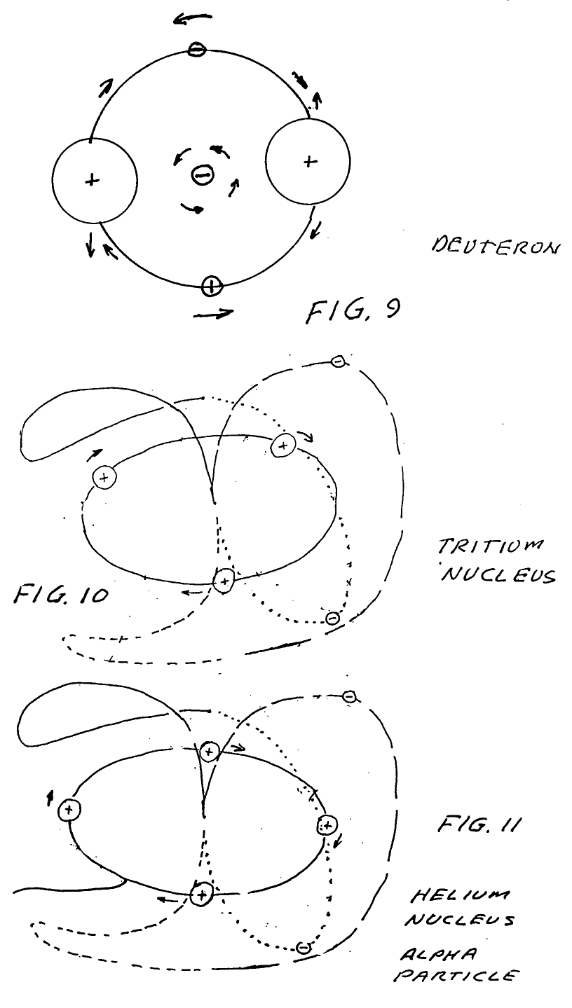

A model of the deuteron is shown in FIG. 9. The deuteron has a mass that is 2.22 MeV less than the combined masses of a typical proton and a neutron. In my preferred model of the deuteron (the deuterium nucleus), the deuteron is basically two protons circling an electron located in between them. The neutron's 0.74 MeV (1.56×10⁻¹⁴ m diameter) entron may be circling the electron and passing through the center of both protons. For this proposed configuration, both protons in the deuterons have less captured entron energy than the normal proton. The captured entron or entrons energies for each of these protons are in the range of about 7.2 minus 1.11 or about 6.1 MeV. Therefore, these protons would be moving faster than the proton nucleus of a typical hydrogen atom (which are substantially stationary) but much more slowly that the protons of alpha particles which are proposed to travel at about 36 percent of the speed of light. I do not know what their velocity is but if it is in the range of about 2.1 percent of the speed of light the Coulomb and centripetal forces would cancel. The reader should note that the tronnies of the entron are circling counter clockwise while the two protons are circling clockwise. My guess is that the electron itself is a naked electron moving at 2.18×10⁶ m/s in a tight circle inside the circling protons.

Tritium

A model of the tritium nucleus is shown in FIG. 10. The tritium has a mass 5×10⁻²⁷ kg (equivalent to about 2808 MeV). If we subtract the mass of the orbiting electron, we are left with a mass/energy of about 2,807 MeV for the tritium nucleus. The mass in MeV of a proton and two neutrons adds up to 2817.403 59 MeV. The difference of 9.546 MeV represents lost entron energy in the course of the fusion of the protons and two neutrons to form the tritium nucleus. One third of this value is about 3.18 MeV. Therefore, I assume that each of the three protons in the nucleus is carrying entron energies of 7.20 MeV −3.18 MeV or about 4.02 MeV. This would indicate that the velocity of each of the three protons in the tritium nucleus is greater than that of the protons in the deuterium nucleus but less than the velocities of the protons in the alpha particle (i.e. somewhere between 2.1 percent and 36 percent of c).

The Alpha Particle

In my proposed model of an alpha particle, FIG. 11, the protons have lost all of their entrons and as a consequence each has masses equivalent to about 931 MeV about 7 MeV less than the standard proton mass. That energy is released during the hydrogen to helium fusion processes. The protons relieved of their slowing down entrons circle in the alpha particle at about 36 percent of the speed of light. Two electrons orbit around and through the center of the four circling protons as shown in FIG. 11. Since the alpha particle has electrons circling at its surface, it can be attractive to other positively charged particles such as other alpha particles, deuterons and protons. But this attraction is only within a limited range of the center of the alpha particle and the particle would be repulsive to other positively charged particles at long ranges. Like electrons and protons, a “naked′ alpha particle is self propelled by internal Coulomb forces. I estimate its naked enegy at about 7 MeV. An alpha particle like the electron and the proton can capture entrons to slow it down. Entrons with energies of about 7 MeV will slow down the alpha particle to close to zero. This may help explain peculiar behavior of helium at very cold temperatures close to absolute zero degrees Kelvin. My understanding is at these temperatures the helium acts like a fluid and will climb up the walls of its container.

Nuclei of Atoms

The nuclei of atoms are built up of alpha particles, protons and neutrons, but entrons are also important parts of nuclei. Coulomb forces hold nuclei together. In the nuclei of atoms the neutron probably loses its identity as a neutron and its electron is attached equally as strongly to another proton as it is to the proton in the neutron that brought the electron into the nuclei. In my models of atoms larger than helium, alpha particles maintain their structures. Since the perimeter of the alpha particle is the major part of the paths of the two electrons (see FIG. 11), the alpha particle can be attractive to other alpha particles at close but not touching distances. The repulsive forces would be infinite if they touched and large if they were separated by a few 10⁻¹⁵ m. But at about 10⁻¹⁵ m the forces between two alpha particles could be attractive. Also, at these close distances an alpha particle could be attractive to a proton due to its structure where the negative charges are concentrated mostly at the outside region of the alpha particle. The electron brought into nuclei also provides attractive forces helping to hold alpha particles and protons closely together inside nuclei. The reader should note again that no strong force is needed to hold nuclei together, just the Coulomb forces. So the nucleus of an atom is (according to my preferred model) nothing more than a combination of protons and negatrons (along with a variety of entrons) all in dynamic equilibrium.

### Self-Propelled Subatomic Particles

I proposed above that naked electrons provide their own self propulsion. One on the most important proposals first made in this specification is that all naked subatomic particles are self-propelled at very high speed. At the basic element level, we live in a very fast moving universe! The internal Coulomb forces of naked sub-atomic particles ( with the exception of the at-rest entron) are not in equilibrium unless they are moving at high speeds. We start with tronnies. They are really the very basic elements, and a fundamental feature of the Ross Model is that they can never travel more slowly than the speed of light. Entrons comprised of two tronnies circling at 1.57 c can be at rest in matter, but if released in the form of a photon they are self-propelled at the speed of light. Naked electrons self-propel themselves at about 2.18×10⁶ m/s with kinetic energy of about 13.5 eV. Naked protons self-propel themselves at about 3.8×10⁷ m/s with kinetic energy of about 7.7 MeV and naked alpha particles self-propel themselves at about 1.8×10⁷ m/s with kinetic energy of about 6 MeV. As described above electrons, protons and alpha particles are required to capture an entron (or possibly several entrons) in order to participate directly in our slow moving society; although they can in their natural naked state operate as integral parts of a nucleus of an atom (in the case of the proton and the alpha particle) or the nucleus or an atom (in the case of the electron).

### Atoms and Molecules

Atomic Structure

Atomic structures of the various atoms in the periodic table, according my preferred models, are similar to prior art models with electrons circling the nucleus. However, according to my preferred models, the circling electrons (except for conduction electrons) drive themselves around the nuclei at a speed of 2.18×10⁶ m/s (about 1,300 miles per hour) by their own internal Coulomb forces. Conduction electrons are slowed down by captured entrons and are free to roam about through atomic and molecular matrices at speeds much slower than 2.18×10⁶ m/s. For atoms with more than two orbiting electrons, the additional electrons are forced into larger orbits. These produce the atoms with the orbits that are well described in the prior art.

The Hydrogen Atom

The Ross Model of the most abundant hydrogen atom consist of a proton that has been slowed down to near zero velocity by the capture of an entron with energy of about 7 MeV and a diameter of about 1.65×10⁻¹⁵ m. The proton which is the nucleus of the hydrogen atom in its “ground” state is orbited by a single electron with no captured entron. This “ground state” electron has a velocity of about 2.18×10⁶ m/s. At this velocity with its mass m=9.11×10⁻³¹ kg, its centripetal force balances the Coulomb force of attraction between the proton and the electron only if the radius of its orbit is r=0.53×10⁻¹⁰ m. The frequency of its orbit is f=v/2 πr or f=6.546×10¹⁵/s and its angular momentum is 1.052×10⁻³⁴ kgm²/s The electron loses its kinetic energy as it captures entrons with energy of less than 13.6 eV. For example, if the electron captured an entron with energy of 10.216 eV its kinetic energy would be reduced to 3.38 eV and its velocity would be reduced to 1.08×10⁶ m/s and its stable orbit would increase from 0.53×10⁻¹⁰ m to 2.17×10⁻¹⁰ m and its angular momentum would increase by 1.052 to 2.14×10⁻³⁴ kgm²/s. If it captured an entron with energy of 12.117 eV, its kinetic energy would be reduced to about 1.483 eV, its orbit radius would increase to 4.85×10⁻¹⁰ m and its angular momentum would increase again by about 1.052×10⁻³⁴ kgm²/s to about 3.19×10⁻³⁴ kgm2/s. The energies of the photons in the Lyman series absorption and emissions for hydrogen are 10.2166 eV, 12.1170 eV, 12.78 eV, 13.09 eV, 13.26 eV, 13.35 eV, and 13.41 eV.

Neils Bohr long ago recognized that electron orbits of the hydrogen atom are stable only if the angular momentum of the electron, mvr, was an integral multiple of h/2 π or mvr=nh/2 π. He said if the electron were in any other orbit the orbiting electron would radiate energy quickly and spiral into the nucleus. Under the Ross Model of the hydrogen atom ground state electrons (electrons with no captured entrons, have kinetic energy ½ mv2 of 13.5 eV (corresponding to its naked speed of 2.18×10⁶ m/s) and cannot lose energy by radiation since they are naked and have no entrons to radiate. They do lose kinetic energy by capturing entrons and in that case the electrons move to a higher orbit with less kinetic energy but with potential energy in the form of the captured entron. The electron does sooner or later radiate that entron in the form of a photon which we can detect as an ultraviolet line. If the electron were to capture an entron with energy of 13.6 eV, its kinetic energy would be reduced to zero in which case the electron's stable orbit would be very large (mathematically infinity). If the electron is close enough to be attracted to the nucleus, the before the electron reaches the nucleus its entron would be dislodged, giving back to the electron its natural speed of 2.16×10⁶ M/S so it would resume its natural orbit at 0.53×10⁻¹⁰ m.

The intensity (number of photons) in the Lyman series decreases as the energy of the photon increases. The largest energy photon in the Lyman series with a substantial intensity is a 13.41 eV photon. Its intensity is only one percent of the intensity of the lowest energy photons (10.2165 eV) in the series. Electrons with this captured entron are still moving pretty fast: 0.258×10⁶ m/s and its orbit is still small with a radius of only 38.01×10⁻¹⁰ m. The stable orbit of an electron in a hydrogen atom with a velocity of zero would be infinity.

Ionization Potential

The ionization potential of hydrogen is about 13.5 eV. The entron of this photon gives enough potential energy to an electron in its ground state (i.e. an electron with kinetic energy of 13.5 eV and traveling at 2.18×10⁶ M/s) to slow it down to zero speed and move its equilibrium orbit to infinity. The ionization potential for ionizing the first electron of helium is 24.587 eV (the highest first electron ionization potential of all atoms). To knock the second one out takes a photon with energy of 54.418 eV. In the ground state helium atom, both orbiting electrons are in their ground state traveling at 2.18×10⁶ m/s. They are on opposite sides of the nucleus at all times going in the same orbit direction so their spins are opposite and cancel. Their orbit radius is about twice that of the hydrogen atom since the nuclear charge is twice as great. A 13.5 eV entron would give one of the electrons zero velocity but would not cause it to be ejected. Its orbit would be higher than the ground state electron the Coulomb force from the nucleus will hold the electron in place in a very unstable configuration where it would be battered severely by the ground state electron and would lose its low energy entron quickly. With an entron with energies of 24.587 the electron has about the same speed as the ground state electron but will be heading in reverse on the opposite side of the nucleus which is not a stable situation, since the spins of both electrons are now in the same direction. I suspect that the entronned electron gets a boost from it ground state partner to escape the atom with its entron. The second electron in the ionized helium requires a 54.418 eV entron to excape. With this entron the electron has a kinetic energy of 54.418 eV minus 13.6 eV, or 40.818 eV or 65.4×10⁻¹⁹ J. Its velocity is determined from: E=½ mv is:
v²=2(65.4×10⁻¹⁹ kg-m²/s²)/9.109×10⁻³¹ kg
v=3.79×10⁶ M/s

Its stable radius at this velocity determined by r=ke²2/mv² is: 0.17×10⁻¹⁰ m. But its entron has a diameter of about 0.7×10⁻¹⁰ m, so this orbit could not be a stable and the electron is ejected.

All this looks pretty logical to me and I think it is the best description of the hydrogen atom that I have seen and can understand. As Niels Bohr discovered for hydrogen like atoms stable orbits multiples of the angular momentum of the lowest orbit. The reason for this may be that it is easier for an orbiting electron to capture an entron if the capture does not change the angular momentum of the atom. So the captured entron will only be one that slows the electron down just the right amount so that at the next higher orbit the angular momentum is not changed.

### Heat and Temperature

Heat is nothing more than entrons (circling tronnie pairs) temporarily trapped in matter. Temperature is a measure of that heat. We warm up when our bodies absorb the entrons of photons radiated from a camp fire or the sun, and we cool down when our body radiates photons with wavelengths in the millimeter wave range. The entrons of microwave radiation warms our TV dinners. We typically must wait a few minutes for some of the entrons to radiate away so that the dinners have cooled enough for us to eat them.

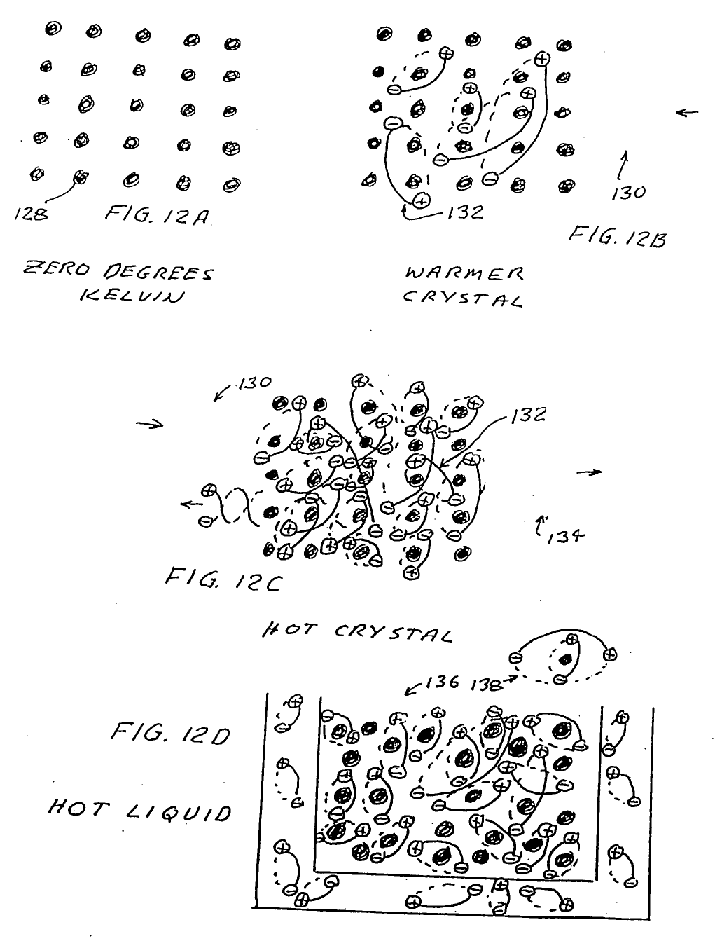

According to this embodiment heat and temperature, of a solid, liquid or gas, are expressions of entrons (or tronnie pairs) which have been captured and are temporarily located in the solid liquid or gas. According to this model, all atoms and molecules naturally include a number of tronnie pairs (entrons of neutrinos, gamma rays and other photons) that help define the basic atom or molecule in its natural unheated state (i.e., its absolute zero temperature state). FIG. 12A depicts the atoms 128 of a solid crystal at zero degrees Kelvin. The atoms of this crystal comprise many entrons, but these entrons are part of the make-up of the crystal and there is no force within the crystal structure encouraging them to leave, even at a temperature of absolute zero. However, the crystal can accommodate a great many additional entrons, and if it is placed in an environment warmer than absolute zero, entrons will enter the crystal as indicated at 130 in FIG. 12B and may remain as shown at 132. The more entrons that enter through radiation or conduction, the warmer the crystal becomes. Some entrons may also leave, but there will be a net inflow until the crystal becomes in equilibrium with its environment. FIG. 12C depicts a hot crystal with entrons entering 130 and entrons leaving 134 and many remaining temporally trapped 132. Entrons may retain their entering frequencies inside the crystal or as the result of interactions inside the crystals with other entrons that are part of the atoms, electrons or with other entrons, they may have their frequencies increased or decreased. If entrons are continuously added to the solid crystal faster than they are released the number of entrons in the crystal will grow and the entrons will become more and more crowded. This will cause the crystal structure to expand and eventually disruptive forces of all of these entrons will overcome the forces holding the atoms together in their crystal structure. The crystal may melt as depicted in FIG. 12D. The atoms of the crystal move about more or less randomly as indicated at 136 but Coulomb forces continue to provide a net attraction between the atoms. However, occasionally entrons circling an atom will produce net repulsive forces to cause atoms to evaporate and leave the melted crystal as shown at 138 taking entrons along. Continued heating of the melted crystal will put more and more entrons into the liquid. This has the effect of forcing the entrons into smaller and smaller circles (i.e., higher and higher frequency entrons) and as a result the entrons leaving as photons of thermal radiation have on the average shorter wavelengths. Also, the shorter diameter circles tend to cause the entrons to circle individual atoms. (In a molecular fluid such as water the entrons will tend to circle molecules or small groups of molecules.) This reduces the attraction between the atoms in the fluid and more and more of them will become disassociated from the liquid, i.e., they eVaporate. FIG. 12E shows all of the atoms of the original crystal evaporated and completely filling the container as vapor. Each atom is encircled by a number of entrons producing a vapor of atoms and captured entrons and the atoms (with their associated entrons) repel each other and the container creating a pressure in the container. Adding more entrons to the vapor in the form of radiation or convection through the container will increase the number of entrons encircling each atom. Entrons travel from one atom to another and to and from the walls of the container producing a substantial equilibrium among the atoms in the vapor. The temperature is a measure of the number of entrons per atom throughout the process of the heating of the crystal from its absolute zero state to its hot vapor state.

### Radio Waves

Radio waves may travel as photons as described above. However, it is hard for me to imagine a radio photon that is a mile or more wide, which would be the case for photons in low frequency radio beams. It may be that, low frequency radio waves travel out from antenna as alternating pulses of plus and minus tronnies and generally not as photons. In each pulse the tronnies (all of the same charge) propel themselves spherically outward at the speed of light. As they travel outward each tronnie leaves a trail of Coulomb force which helps pull the oppositely charged tronnies in the immediately following pulse of tronnies. When these pulses of tronnies encounter an antenna they are absorbed by it, charge it with their charge so that the antenna is attractive for the oppositely charged tronnies in the immediately following pulse of tronnies. A properly designed electronic circuit with an oscillator, oscillating in synchronization with the radio transmitter isolates and detects the radio signal imposed on the radio beam. Higher frequency radio waves such as those produced by half-wave antennae probably travel as polarized photons like the one shown in FIG. 3C.

### Uncertainty Principal

Heisenberg's Uncertainty Principal enjoys wide support by modern scientists. Therefore, I am naturally reluctant to say it is wrong. I do suggest that scientists may want to think about its application in light of the Ross Model of the Universe and the existence (if I am right) of tronnies that are the building blocks of everything in the universe. For example, if an electron is comprised of three tronnies held together in dynamic equilibrium in their “triple tronnie twirl” as shown in FIG. 4, and if its energy (above its rest mass) is provided by entrons trapped in its Coulomb force fields, then we could think of the electron as comprising its trapped entrons. If this is the case, the electron is made up of at least five tronnies each circling at speeds of 1.57 cor greater. These trapped entrons determine the electron velocity and thus its momentum. They also help create uncertainty as to the location of the electron. Since higher energy entrons correspond to smaller entrons, there probably is some relationship between momentum of the electron and the position of the electron. What I'm saying here is that I, like a great many other people, do not fully understand the uncertainty principal, but it may be that it is not basically inconsistent with the Ross Model. Thus, we may discover that once we have agreed on what th electron looks like, we may be able to determine its exact speed and the exact location of all of its parts as a function of time like we now do for automobiles, jet planes and rocket ships.

I understand that the current scientific thinking is that the electron cannot exist inside the nucleus because to do so would violate Heisenberg's Uncertainty Principal. The Ross Model is surely at odds with this thinking. We have electrons and positrons inside protons! I suspect that for years we have been lead astray by Professor Heisenberg. According to the Ross Model as explained above, the nucleus of atoms includes electrons and protons (each proton comprising one electron and two positrons each of the three having at least one neutrino entron giving it extra mass and speed).

### deBroglie Wavelength

According to prior art theories particles can have wave-like features as light can have particle features. The deBroglie wavelength is:
Wavelength=h/momentum
Experiments indicate that an electron with a velocity of 6×10⁶ m/s has a wavelength of about 1.2×10⁻¹⁰ m. According to the Ross Model an electron with a speed of 6×10⁶ m/s would possess kinetic energy Ek of about 1.64×10⁻⁷ J. An entron with this energy would have a diameter d′ of:
d′=hc/106.6 Ek
d′=(6.6×10⁻³⁴ Js)(3×10 ⁸ m/s)/(106.6)(1.64×10⁻¹⁷ J)=1.13×10⁻¹⁰ m

### Chemical Energy

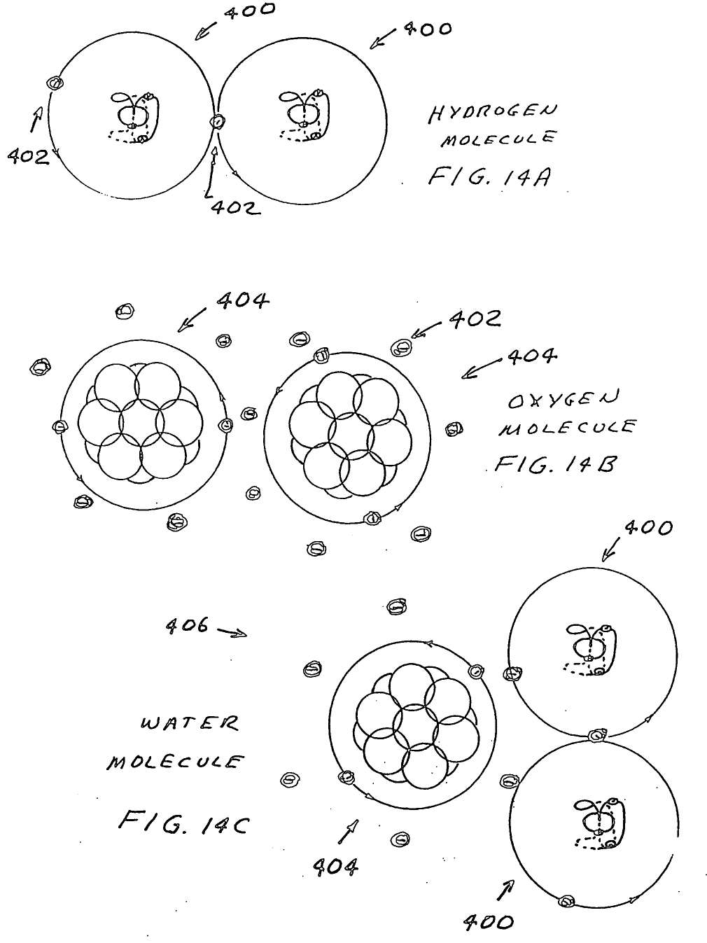

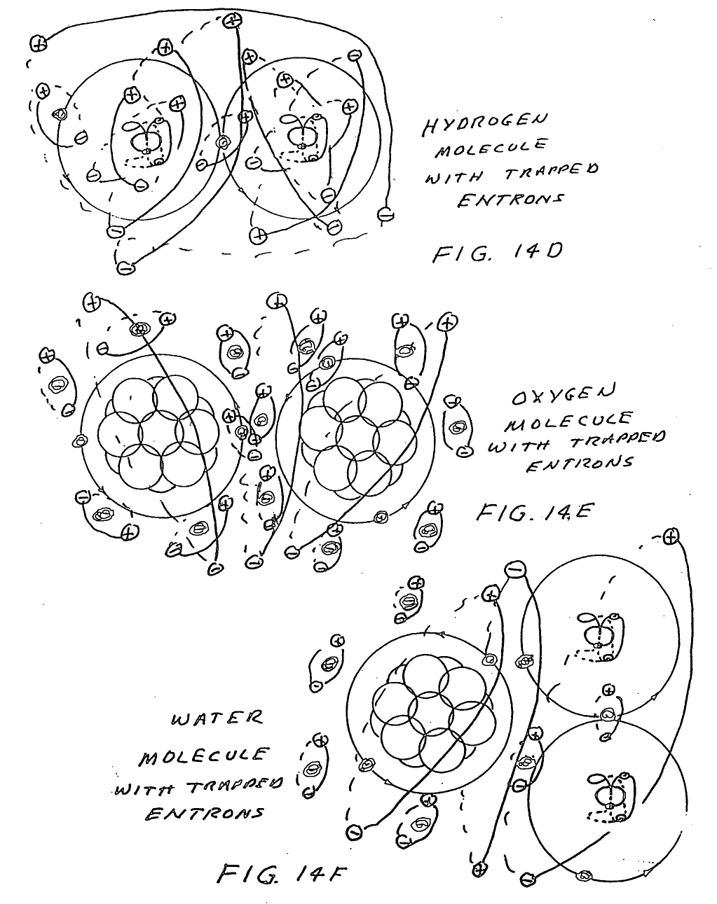

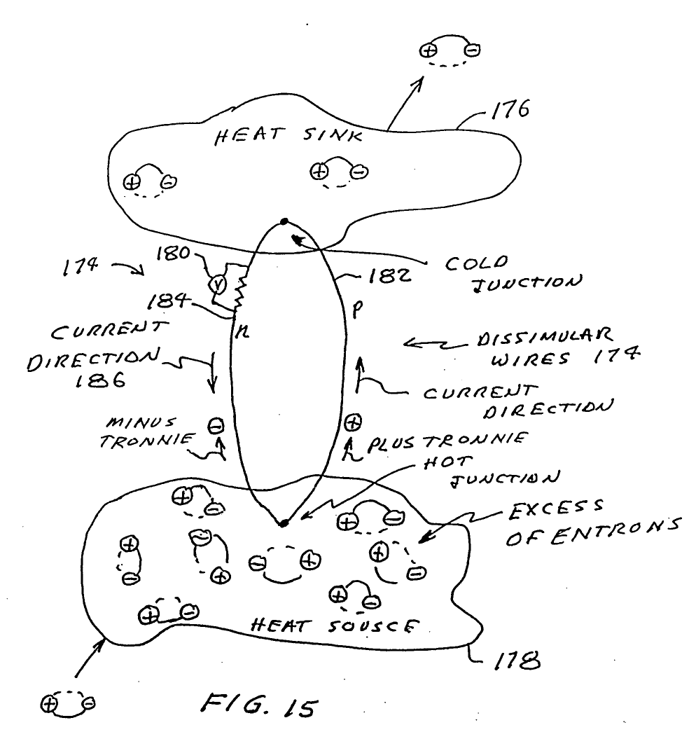

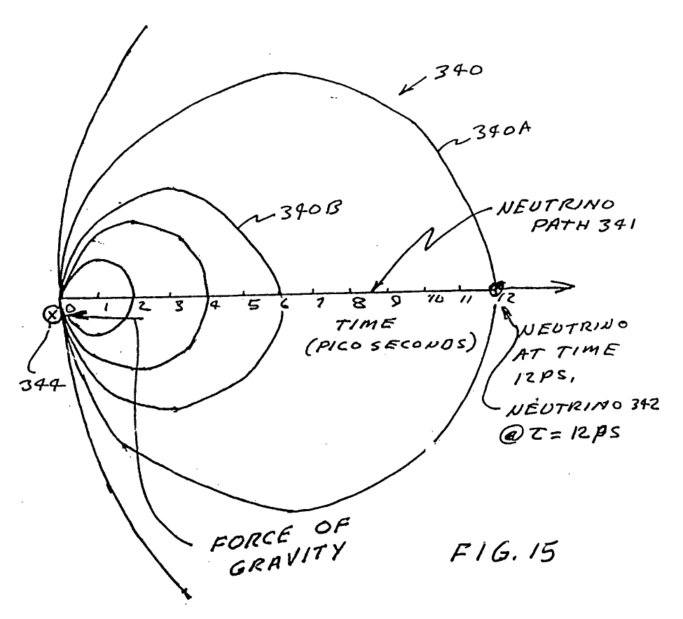

FIG. 14A depicts a hydrogen molecule which is two hydrogen atoms 400 sharing electrons 402. Presumably both electrons are ground state naked electrons circling at 2.18×10⁶ m/s. FIG. 14B shows an oxygen molecule, which are two oxygen atoms each with six electrons in their outer shells and sharing two electrons to complete the eight electrons desired shell. The two shared electrons may have captured entrons to slow them down. All other electrons are orbiting at 2.18×10⁶ m/s. FIG. 14C depicts a water molecule H₂O 406. FIG. 14D depicts a hydrogen molecule like that shown in FIG. 14A but with a large number of trapped entrons. FIG. 14E shows an oxygen molecule also with a large number of trapped entrons. These numbers of entrons in the hydrogen and the oxygen is assumed to represent equilibrium states at a particular temperature. FIG. 14F depicts a water molecule at the same temperature as the hydrogen and oxygen temperatures, but according to the drawings the water molecule has around it many fewer entrons than the entrons in the hydrogen molecule plus one half of the entrons in the oxygen molecule. This example is suppose to show that when hydrogen burns in oxygen to form water the energy produced is excess entrons which are released in the process in the form of photons. The point here is that in all exothermic reaction the heat released is excess entrons, usually as photons. In many reactions heat must be added to make them go. In these cases the natural state of the product needs more entrons than the constituents at the same temperature.

### Fission and Fusion

According to the Ross Model a substantially stationary hydrogen 1 atom contains a 7 MeV entron slowing the proton down to a speed close to zero. When hydrogen four protons are fused to make a helium nucleus these four 7 MeV gamma ray entrons are release as gamma ray photons that provide the destructive force of hydrogen bombs and the warmth of our sun. In fission uranium 236 (U-235 plus a neutron) has more tronnie pairs (very high energy trapped photons) associated with it than the fission products resulting from the fission. So that, again, heat energy is released in the form of high-energy photons along with two or three excess neutrons and two atomic fission product.

### Gravity

In prior art models of the universe, there is speculation that a particle called the “graviton” is the carrier of gravity although no one has ever seen a graviton despite extensive searches for them. The existence of neutrinos is well accepted in prior art theories with about 150 million of them passing through every square centimeter of earth each second. In all references to them that I have seen there is no indication that neutrinos carry any charge or charges and there is no indication in the prior art that the prior art neutrinos have any relationship to gravity. There is some question in the prior art as to whether neutrinos have mass. According to the Ross Model, the neutrino is nothing more than a high frequency, short wave length photon, as described above. It like all photons has no net charge but carries two equal and opposite charges. Like all photons the neutrino is comprised of an entron made up of a circulating pair of tronnies that travel through space. The width of the entron (i.e., the maximum separation of the two tronnies is much smaller than atomic dimensions so it passes right through almost all atoms in its path and is only very rarely stopped even when passing through bodies as large as the earth. FIG. 16 shows Coulomb fields 340 produced by a neutrino photon 342 passing through the earth. It is traveling through the earth at equal to a substantial fraction of the speed of light.

It like all photons is pushed by its own Coulomb force fields as indicated at 342 in FIG. 16. Circle 340A represents a cross section of the fields at t=12 ps that emanated from neutrino 342 at t=6 ps. Circle 340B is the field at t=6 ps that emanated from neutrino at t=3 ps. The reader should understand that the fields from all points along the path of neutrino 342 define spheres that intersect the path 341 just behind neutrino 342. Of these only field 340A that emanated from the conductor into the stream when the conductor passes back through the stream in the neutrino is passing. The first thing to realize is that tronnies (such as a plus tronnie 344) near the path of a neutrino (as shown in FIG. 16) never feel effects of the neutrino until after the neutrino passes it. This is obvious from our earlier discussions of photons and from FIG. 16. However, after the neutrino 342 passes plus tronnie 344, plus tronnie 344 does feel the repulsive Coulomb forces emanating from the plus tronnie part of neutrino 342 and is repelled by it. In fact at every instant along the path 341 of neutrino 342 a Coulomb wave is emitted that repels tronnie 344 according to the physics of the Coulomb inverse square law. Thus, the matter in which tronnie 344 is trapped feels a force pushing it toward the sun (i.e., the origin of the neutrino photon 342). This is the source of the sun's gravity carried by the neutrino from the sun to the earth. Thus, neutrino photons not gravitons are the carriers of gravity!

“OK”, a reader might ask, “Where does the earth get its gravity attracting me to its surface?” The answer is that a significant portion of neutrinos from the sun are scattered from protons and maybe electrons in the earth and some are absorbed then later released in all directions. So (except for the neutrinos passing through the earth from the sun and other neutrino sources) the total of the matter penetrating photons coming out from the earth is relatively uniform in all directions. These matter-penetrating photons apply a reverse force to the charged elements inside our bodies thus pushing us toward the center of the earth. In a mass like the earth an equilibrium will be reached in which the number of neutrinos absorbed in all of the protons and electrons in the earth reaches a constant level which means that the earth is also a major source of neutrinos that are emitted in all directions. This source is (according to this feature of the Ross Model) the carrier of the earth's gravity.

### Black Holes

As explained above neutrino photons from black holes provide the gravity force galactic matter into the black holes. In the black holes the protons of the galactic matted are destroyed and each destroyed proton releases three 939 MeV entrons that eventually escape the black hole as neutrino photons seed our spherically creating a inverse square flux of neutrino photons pushing more galactic matter back into the black hole to be consumed releasing more neutrino photons. Thus, the black hole slowly eats its galaxy and any nearby galaxy or it is eaten by the black hole in a nearby galaxy. Remember every proton comprises three neutrinos. So if protons are destroyed inside a black hole they provide a tremendous source of neutrinos. Thus, the only thing getting out of the black hole is neutrinos that are then the agent for pushing more matter into the hole. The black holes are also sucking in the hydrogen dispersed in interstellar space and releasing its neutrinos to go out and get more matter.

### Receding Galaxies

So, a reader might ask. Why are galaxies moving apart from each other. An answer may be that a tremendous number of hydrogen atoms and molecules are distributed sparsely in the inter-galactic space. These hydrogen atoms and molecules would absorb a percentage of neutrino photons emitted from the galaxies mostly the black holes in the galaxies and then re-emit the neutrinos in random directions. Thus, reducing the effectiveness of these neutrinos as gravity carriers from their source. However, longer wavelength photons from each galaxy do penetrate the intergalactic space (obviously because we can see them), but these are absorbed in the matter of the galaxies they illuminate applying a repulsive force causing most galaxies to recede from each other. Only nearby galaxies are attracted to each other because at close ranges neutrino photons are not sufficiently diminished by the presence of the inter-galactic hydrogen.

### The Death and Life of Universies

Recycling on a Grand Scale

Each universe has a lifetime. It is born from a basketball size in a Big Bang, expands very quickly at first then more slowly for a long period of time (such as about 50 billion years) to a volume many billions of light years across; then it contracts for another long period (such as another 50 billion years) then it collapses to basketball size and dies in another Big Bang that is the beginning of the next universe. This is recycling ona grand scale! So, according to this model the universe we live in is a number in a series of universes. I doubt if we will ever know what the number of our universe is. We could guess. For example, we might propose that our universe is Universe 47, created at the demise of Universe 46 and when our universe ends in the next Big Bang its recycled tronnies will create Universe 48. Scientist estimate that our universe is about 15 billion years old and is still expanding. The Ross Model attributes this expansion to the pressure produced by the impact of relatively low energy photon exchanged between far away galaxies. Neutrino photons are absorbed and/ or scattered by hydrogen currently sparsely dispersed in inter-galactic space.

The End of the Universe

It may be that when a sufficient portion of the free hydrogen in the space between galaxies has been sucked into galaxies, the neutrinos from the black holes of the separate galaxies will begin to pull all galaxies together into one gigantic black hole. This largest of all black hole may exist for a long time continuing to suck in surrounding matter and breaking it down, first to neutrons and then destroying the protons in the neutrons to produce neutrino photons and gamma ray photons as described above. At some point in the life of the largest of all black holes the process of proton destruction will accelerate providing an exponential increase in the black hole's gravity which further accelerates the proton destruction so that in a very short period (maybe less than a few seconds) the black hole collapses to a size smaller than a basketball and all remaining protons and electrons are destroyed so that nothing is left but gamma ray photons and neutrino photons which explode out a basketball size birthplace in a Big Bang to create the next universe.

The Birth of the Next Universe

Following the Big Bang destruction of this largest of all black holes, the released neutrino and gamma ray photons expand out much faster than the speed of light. This is the inflation period of the next universe. A reader may ask, “How can photons go faster than the speed of light?” In the Ross Model light speeds up as it passes into a Coulombic field moving in the same direction as the light. For example, if a Coulombic field moving out at the speed of light is produced by a group of photons expanding from the center of the black hole, then a second group of photons surrounding the first set could move out at twice the speed of the first group. Then a third group of photons surrounding the second group could move out at three times the speed of light. We can imagine a great many of groups of photons; so the speed of the last group could be any speed many times faster than the speed of light. The prior art suggest that at the very beginning of our universe there was this inflation period where the universe did in fact expand out much faster than the speed of light, but the prior art does not have an explanation for the fast expansion. And this explanation is at odds with the prior art theories since those theories limit all speed at the speed of light. The Ross Model has no such limit.

The principal products of the destruction of protons and the BIG Bang as explained above are gamma ray photons and neutrino photons. When the new universe has expanded sufficiently, gamma rays will begin combining to form electrons and positrons each of which can capture one of the many neutrino photons that were released to produce very high-energy electrons and positrons. These now combine to form naked protons. Some of these naked protons combine with three other naked protons to form alpha particles but most capture a 7 MeV entron and form hydrogen atoms. During this process the creation of hydrogen and helium retards the distribution of lower energy photons but not neutrino photons. The lower energy photons provide an expansion force and the neutrino photons provide a gravitational force so that matter in the universe tends to congregate. At great congregations lower energy photons are absorbed and neutrino photons are scattered randomly out of the congregation providing a type of gravity for the congregation producing further congregation. So stars and galaxies and black holes are born. Stars generate larger atoms in fusion processes and heavier atoms are produced in explosions of stars. Planets are formed from the dust of the universe and in due course life eVolves on some of the planets.

### The Speed of Light and Special Relativity

Photons in a light beam slow down when passing through a Coulombic reference frame (such as a laboratory where light speed is being made) moving opposite the beam. And they speed up when the reference frame is moving in the same direction of the beam. Based on this preferred model, time does not slow down when you go fast and meter sticks do not get shorter. Simultaneous events are simultaneous in all reference frames. Time is absolute. When an astronaut returns to earth he and his twin brother can have their next birthday party together at exactly the same time.

Michelson and Morley in 1887 determined that the measured speed of light on earth was constant in all directions even though the earth was moving at a significant fraction of the speed of light through the universe. With this information Albert Einstein based his Special Theory of Relativity of the assumption that, “The speed of light in a vacuum has the same value c in all directions and in all inertial reference frames.” Based on this assumption, he convinced the world that time must slow down if you go fast and that simultaneous events in a first reference are not simultaneous in a second reference frame moving relative to the first reference frame. More recently experiments have shown that the speed of light is independent of the speed of the source of the light. This has been taken to support Einstein's assumption that the vacuum speed of light is always constant at c. This in not the case.

Photons push themselves through a Coulombic reference frame in the same manner that a fish pushes himself in a flowing river. The fish's net speed is the sum of his speed and the river's speed. The photon's speed is the sum of c plus the speed of the Coulombic reference frame through which it is traveling. If the frame is moving opposite the photon direction at 0.1 c, then the photon speed will be 0.9c. If the frame is moving at 0.2c in the direction of the photon the photon speed will be 1.2c. In both cases scientist in the reference frame will measure the speed of the photon as c, but they will not be measuring the true speed of the photon.

### String Theory

I do not understand string theory; however, I do understand that many very smart people believe in it because it produces results that are consistent with experimental results. The End of the Universe

### Model is Evolving and Getting Better

I admit that some of my explanations are speculative and I am sure that people more familiar with particular technologies than I can improve on my explanations. When they do I will just modify my model to accommodate the better explanations. As is clearly obvious from a reView of the parent patent applications preceding this one, I have already modified my model numerous times since I began developing it about four years ago. The model has gotten simpler with each modification.

The reader should understand that this theory is not fully developed. It has been evolving for about five years. It started with an attempt to show that protons could be made from positrons and electrons. A five electron model was proposed (three positrons and electrons orbiting one of the positrons fast enough that their velocity very close to the speed of light would increase their mass by about 900 times. Later on I developed the idea that electrons must be made from photons. This seemed likely since that is how electrons are made in pair production. What was added was the notion that both photons and electrons are made from charged things, called tronnies. Since tronnies have no mass, they could go faster than the speed of light; therefore, they could be pushed by their own Coulomb force field. My first attempt at an electron model had one tronnie in the center with two opposite tronnies orbiting. Once I had an electron model made from the constituents of photons, I went to work trying to make everything out of tronnies. I developed models for heat, electricity, magnetism. I at this point convinced myself that everything in the universe must be made from tronnies. My first electron model was not very satisfying because nothing seemed to keep it from collapsing on itself. Also, it was hard to understand how the central tronnie could go as fast as the speed of light. Then I developed the tripple tronnie twirl and this model seemed perfect. It had spin. It had to have a non-zero volume since the outer tronnies had to pass through the circular path of the central tronnie. Not only that, it seemed to provide a good model for the proton especially if I was correct that captured tronnie pairs provided electrons with their excess energy (and mass). Having gone this far, maybe I really could show the possibility of everything in the universe being made from tronnies and all forces in the universe being derived from tronnies.

The most difficult was gravity. The breakthrough was my realization that neutrinos might be photons and (like photons) be comprised of two opposite charges. This is almost too simple. I had tried for almost three years to describe gravity in terms of the Coulomb force. My calculations would not work out. I could never come up with an inverse square relationship. Now, however, I realized that the thing that was known in the prior art as a neutrino might really be a high-energy photon. The neutrino flux was known to be huge and it decreases from its source as the inverse square. I had earlier showed that a photon (or a tronnie for that matter) traveling at the speed of light exerts no force in front of itself but would exert a force behind itself pushing toward its source. And almost all neutrinos form the sun were thought to pass completely through the earth, billions and billions and billions of them each second, all pushing the earth back from wince the neutrinos came. This must be gravity! I think I got it! I think I got it! However, I have later revised my neutrino model. My neutrino as explained above is not the prior art neutrino. My neutrino is a very high energy photon. And maybe they are all produced in black holes as the result of proton destruction. But these neutrinos do provide the gravity of the universe.

Another important improvement has been my discovery and identification of the entron the improved description of the photon with the entron carrying the photon energy. This allowed me to correlate the photon's energy with the entron's integrated Coulomb forces. Still another improvement has been my realization that the speed of light slows down or speeds up when it passes through a Coulombic force field. So its speed measured by people and equipment moving with the Coulombic force field is always constant. Thus, the vacuum speed of light is not constant. This meant that most of the complicated features of the Special Theory of Relativity are wrong. Time is absolute and is the same in all reference frames no matter how fast they are moving relatively to each other. Things do not shrink or stretch when you go fast. They stay the same size. Important improvement first described in this application are may discovery that three photons are required for pair production and that subatomic particles are self propelled in their naked state and need to capture entrons to slow down. This latter discovery allowed me to solve a riddle only partially solved by Niels Bohr more than 100 years ago. Most orbiting electrons do not radiate photon energy because they have no photon energy to radiate. This discovery also allowed me to show where fusion energy comes from.

### Correctness of Individual Models

I have in this specification attempted to provide fairly detailed models for all of the basic elements. This has required a very large amount of imagination and speculation on my part. The models presented in this specification (including the models of the photon, the electron, the proton and the model of atomic nuclei presented above) constitute major departures from the most widely accepted theories explaining the makeup of nuclear particles. The Ross Model and this invention is not limited to the specific models I have described. The invention will be limited by the claims that are allowed by the United States Patent Office. The reader should understand that the models presented herein are evolving. Some are going to be proven incorrect in all likelihood. I expect to develop better models. I am sure others will also if it turns out that I am generally on the right track with the concepts described in this specification.

### Testing the Ross Models

Many processes are available for utilizing, testing and develop the models described herein. One process is for a person experienced in modern nuclear physics to evaluate the models as they have been presented in this specification. This can easily be accomplished with a hand calculator. A more sophisticated model would be to utilize a digital computer model incorporating one or more of the models. It should be fairly simple to model the tronnies, the positrons the negatrons the protons and neutrons in the electron and proton models and determine if they are stable. If I am right, these models will show that the electron and proton and their antiparticles should be enormously stable except when they combine with their anti-particles. By making the computer model a little more complicated, it should be feasible to determine how hard it would be to make a proton using the technique described above for doing that. Perhaps then the computer model could be extended to predict the formation of protons in the models during the process that followed the big bang. Once the electron, proton and neutron have been modeled on a digital computer it would be relatively simple to create similar computer models to examine the Nuclear Models. The techniques herein should also be very valuable in the understanding and design of communication systems from radio, microwave to fiber optics. In each case two heretofore unknown things, the tronnie and the entron, are the workhorses in making these systems work. Now we should really understand why these systems work and as a result maybe make them work better.

### Nuclear Tests and Experiments

If computer modeling shows that the models are correct or that modifications or derivations of the models are correct. A next step is to perform some experiments with particle accelerators to test the models or aspects of the models. It may be that current accelerators do not have the capabilities to properly investigate the models. If so and if the models are shown to be possibly correct then perhaps accelerators can be built to properly test the models. Actually, since the filing of the parent to this Application, Applicant has read that already experiments have been conducted in which positrons and negatrons were fired at each other each with high energy and the result was protons! Also, as referred to above, experiments have been reported in which the annihilation of protons and anti-protons produced electrons and positrons. We have known for many years that electrons and positrons can be produced form photons and that the annihilation of electrons and positrons produce photons. All of these experiments support the models described above.

### No Quarks, No Special Weak Force, No Strong Force

This model shows how nuclei can be held together by Coulomb forces which unquestionably exist. Therefore, there is no need to invent nuclear forces for which there is no proof of existence such as the special weak nuclear force and the strong nuclear force. Also, since the above model shows how protons and neutrons can be held together in the nuclei of atoms there is no need to invent quarks for which there is no good experimental evidence.

### Prediction of the Ross Model

Here are some predictions of the Ross Model. A number between 1 and 9 follows each prediction which is my current rough estimate of the probability that the prediction is correct. A “9” means I am more than 90 percent confident I am right. A “1” means that I am more than 10 percent confident that I am right. No number means I don't want to guess on the likelihood of the correctness of the prediction. In any case, I challenge all readers to prove me wrong or right.

Tronnies

Our universe is comprised of nothing but tronnies and things comprised of tronnies. (9)
Tronnies have no mass and no volume. (9)
Tronnies have a charge of plus or minus e (about 1.6×10⁻¹⁹ Coulomb). (9)
The number of plus and minus tronnies in the universe is equal. (6)
Tronnies can not be destroyed. (4)
   Entrons
Plus and minus tronnies combine to form entrons to create an energy quantum. (8)
In entrons, the tronnies circle at speeds of about 1.57 c. (7)
In entrons net integrated Coulomb forces equate to quantum energy. (6)
The entron's quantum energy is equivalent to mass. (6)
   Photons
Each photon is comprised of one entron that is comprised of two tronnies. (9)
The mass of the entron is also the mass of the photon. (6)
The photon mass is one-third of its total energy (5)
In a photon the entron travels at an average speed of twice the speed of light. (6)
   Electrons
Three gamma ray entrons combine to form an negatron-positron pair. (8)
There are an equal number of negatrons and positrons in the universe. (7)
A “naked” electron is comprised of three tronnies. (9)
Most electrons orbiting in atoms are naked electrons. (8)
Naked electrons capturing low-energy entrons slow down. (8)
High energy electrons are propelled by high energy entrons. (7)
   Protons
Each proton is comprises of two positrons and one negatron (8)
Each of the three electrons in the protons has captured the entron of neutrino photon (8)
Captured entrons of neutrino photons represent more than 99.8 percent of the proton mass. (7)
Naked protons are self-propelled with internal Coulombic forces. (8)
Naked protons capture gamma ray entrons to become typical atomic hydrogen. (8)
High-energy gamma ray entrons are given up by hydrogen during fusion processes. (8) Neutrons
Neutrons are protons with an orbiting high energy electron. (7)
The high energy electron is an electron with a captured entron of a gamma ray photon. (7)
   Atomic Nuclei
An alpha particle is comprised of four naked protons and two negatrons. (7)
There is only one basic force operating in the universe, the Coulomb force. (8)
There is no “strong force” holding atomic nuclei together. (9)
There is no such thing as quarks (6)
   Gravity
Gravity is carried by neutrino photons. (7)
Our gravity comes from neutrino photons released from destroyed protons in our black hole. (5)
   The Speed of Light
Light slows down when passing through Coulombic fields heading in an opposite direction. (6)
Light speeds up when passing through Coulombic fields heading in a same direction. (6)
Our earth drags a strong Coulombic field through the universe. (6)

While preferred embodiments of the present invention are described above, the reader should not construe the present invention as limited by the above description. In fact persons skilled in nuclear physics will envision many other possible variations within the scope of the present invention. Also, it is certainly likely that someone who knows a lot more than me about proton experimental data will propose the true model of it based on my basic concept of everything in the universe (including protons) being made from nothing but tronnies. I welcome the help. Accordingly, the reader is requested to determine the scope of the invention by the appended claims and their legal equivalents and not by the above examples.

I claim:

1) A process for modeling elements of the universe comprising a step of utilizing in models negatively charged tronnies, each having zero mass and a negative charge of about 1.9×10⁻¹⁹ Coulomb and positively charged tronnies, each having zero mass and a positive charge of about 1.9×10⁻¹⁹ Coulomb.

2) The process of claim 1 and further comprising steps of:
A) assigning an electric force field to each plus tronnie which expands out spherically from each of said plus tronnie at a very high velocity and produces an attractive Coulomb force on minus tronnies and a repulsive Coulomb force on plus tronnies and
B) assigning an electric force field to each minus tronnie which expands out spherically from each of said minus tronnie at a very high velocity and produces an attractive Coulomb force on plus tronnies and a repulsive Coulomb force on minus tronnies.

3) The process as in claim 1 wherein said very high velocity is a speed of light in a Coulombic field.

4) The process of claim 1, wherein everything in the universe is comprised of only said plus and minus tronnies and things comprised of plus and minus tronnies.

5) The process of claim 1 wherein an entron is modeled as being comprised of one plus tronnie and one minus tronnie.

6) The process of claim 1 wherein a photon is modeled as being comprised of one plus tronnie and one minus tronnie.

7) The process of claim 5 wherein a photon is modeled as being comprised of one entron.

8) The process of claim 7 wherein said entron travels with an average speed of about twice the speed of light.

9) The process of claim 1 wherein said process includes a step of modeling a neutrino photon having a very high energy in excess of 300 MeV.

10) The process of claim 1 wherein said process includes a step of modeling a neutrino photon having a very high energy of about 939 MeV.

11) The process of claim 9 wherein said neutrino photon is the carrier of gravity and represents a substantial portion of mass of protons.

12) The process of claim 1 wherein a negatron is modeled as being comprised of a plus tronnie and two minus tronnies.

13) The process of claim 1 wherein a positron is modeled as being comprised of a minus tronnie and two plus tronnies.

14) The process as in claim 12 wherein said plus tronnie is modeled as traveling in a circular path or an approximately circular path and said two minus tronnies are modeled as orbiting helically around said circular or approximately circular path resonantly with said plus tronnie.

15) The process of claim 14 wherein a proton is modeled as being comprised of a high-energy, high-mass negatron and two high-energy, high mass positrons.

16) The process of claim 15 wherein said high-energy and said high-mass of said negatron and said two positrons is modeled as a consequence of a capture of an entron of a neutrino photon by each of said negatron and said two positrons.

17) The process of claim 1 wherein a nucleus of an atom is modeled as being comprised of protons and electrons held together with Coulomb forces.

18) The process of claim 1 wherein a magnetic force is modeled as being produced by the flow of tronnies into and out of magnetic material.

19) The process of claim 18 wherein the magnetic material is the core of the earth and the tronnies are modeled as flowing into and out of the earth at locations near the north and south magnetic poles.

20) The process of claim 1 wherein the entire universe and its eVolution before and after the big bang is model using only plus and minus tronnies as basic building blocks.
